(19) United States
(12) Patent Application Publication
(10) Pub. No.: US 2026/0353219 A1
(43) Pub. Date: Nov. 5, 2026

(54) MIGRATION OF NODES IN AN IAB COMMUNICATION SYSTEM

(71) Applicant: CANON KABUSHIKI KAISHA, Tokyo (JP)

(72) Inventors: Pierre VISA, RENNES (FR); Pascal LAGRANGE, LA CHAPELLE DES FOUGERETZ (FR)

(21) Appl. No.: 19/124,748

(22) PCT Filed: Oct. 26, 2023
(86) PCT No.: PCT/EP2023/080021

§ 371 Date: Apr. 25, 2025

(30) Foreign Application Priority Data
Nov. 3, 2022 (GB) 2216391.9
Jul. 20, 2023 (GB) 2311148.7

(51) Int. Cl. H04W 36/08; H04W 36/00; H04W 88/08

(52) U.S. Cl. CPC H04W 36/08; H04W 36/0061; H04W 88/085

(57) ABSTRACT

Methods and apparatus for use in a migration process in which a Distributed Unit, DU, of an Integrated Access Backhaul, IAB, node is migrated from one IAB topology managed by a source IAB donor Central Unit, CU, to another IAB topology managed by a target IAB donor CU are disclosed. A method at the source IAB donor CU comprises sending, to the DU of the IAB node, a message for establishing a F1 connection between the IAB node and the target IAB donor CU in a case where the DU of the IAB node is to be migrated from the one IAB topology managed by the source IAB donor CU to the other IAB topology managed by the target IAB donor CU. A method at the IAB node is also described.

### FIELD OF THE INVENTION

The present invention generally relates to methods for use in a process for migrating nodes and traffic between Integrated Access and Backhaul, IAB, topologies of a wireless communication system involving mobile IAB nodes. Particularly, the present invention relates to a method for use in a migration process in which a Distributed Unit, DU, of an IAB node, for example a mobile IAB node, is migrated between IAB topologies.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

The demand for network densification increases due to the rising number of users and higher throughput requirement.

Facing the issues of high deployment costs and time of the wired backhaul networks with network densification, 3GPP has proposed, from release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate. However, millimeter waves are known to be subject to strong attenuations of signal strength in some weather conditions (rain, fog), and to blockage in case of obstacles located in the path between the emitter and the receiver.

To manage these potential radio link failures, a topological redundancy can be provided within the IAB framework, where multiple data paths are set up between the IAB base station directly connected to the core network (also referred to as the “IAB-donor”) and the IAB base station serving UEs (also referred to as the “access IAB-node” for the UEs). Several intermediate IAB base stations (also referred to as IAB-nodes) may be involved in each of the several paths between the IAB-donor and the access IAB-node, thus forming alternative data paths within a multi-hop IAB topology.

Besides, 3GPP has been considering inter-donor redundancy, where an IAB-node, referred to as a boundary IAB node, can access two different parent nodes connected to two different IAB-donors, with each of the IAB-donors managing a different IAB topology (also referred to as IAB network). The boundary IAB-node, even though belonging to a single IAB topology, i.e. belonging to a single IAB-donor for configuration and management, is thus able to route packets from a first IAB topology managed by a first IAB-donor to a second IAB topology managed by a second IAB-donor. The advantage of such inter-donor redundancy lies in the ability for the first IAB-donor to perform offloading by routing some of its packets through the second IAB topology, thus mitigating congestion issues or overcoming radio link failure issues that may arise in the first IAB topology.

There are other situations where an IAB-node becomes a boundary node. For example, in the case of partial migration of an IAB-node, decided by the IAB-donor, where the Mobile Termination (MT) of the IAB-node becomes connected to a single parent IAB-node belonging to another IAB topology controlled by another IAB-donor. This situation may also happen in the case of an IAB-node that experienced radio link failure (RLF) and that has recovered through a parent IAB-node belonging to another IAB topology. In those cases, the migrated IAB-node and its potential descendant IAB node(s) still belong to the initial IAB topology, and such partial migration may be called MT migration. In order to ensure that traffic can be routed through the other IAB topology, MT migration should be followed by traffic migration where the traffic related to the boundary node and its descendant IAB-nodes is routed through the other IAB topology up to the boundary node (i.e. the migrated IAB-node).

Stationary IAB-nodes should only require a single MT migration. Indeed, a backhaul link (defined between two successive IAB-nodes in the wireless backhaul) may experience radio failure due to fluctuations of radio conditions and, for IAB-nodes that do not move, it should be a temporary situation with possible link recovery after some time. Thus, it should not be required for such stationary IAB-nodes to perform multiple MT migrations in the same IAB topology or toward another IAB topology, and the transmission and the handling of multiple protocol messages can be avoided. For the same reason, the migration of the Distributed Unit (DU) of the IAB-node, leaving the control of the IAB-node to a new IAB-Donor, should not be required for stationary nodes. Moreover, it is noted that such DU migration, that may be called full migration, also involves the handover of UEs served by the migrating mobile IAB-node.

Urban environments are usually characterised by a high density of users along with the presence of a significant number of vehicles (e.g. public/private passengers transportation, goods delivery, food trucks . . . ). Some of these vehicles (e.g. buses, trams, trains), may have predictable routes and a significant number of collocated UEs (i.e. passengers' devices). 3GPP is considering that such vehicles could offer an opportunity to increase network coverage and connectivity to the UEs inside the vehicles, or even to UEs in proximity to the vehicles, by installing on these vehicles on-board base stations (or base station elements) that would act as mobile relays. These mobile relays would rely on 5G wireless backhaul (typically IAB, or Integrated Access & Backhaul) for connecting to a fixed donor device.

Thus, based upon the fixed IAB foundations of releases 16 and 17, 3GPP is now considering Mobile IAB systems and architecture, as a part of the release 18 framework, in order to address scenarios focusing on mobile IAB-nodes mounted on vehicles (such as buses, trains, taxis). In such scenarios, mobile IAB-nodes can be referred to as Vehicle Mounted Relays (VMR), providing 5G coverage/capacity to on-board and/or surrounding UEs.

The technical benefits of using VMRs include, among others, is the ability of the VMR to offer good radio link conditions to the nearby UEs. Additionally, comparing with a solution using a UE as relay (i.e. a Sidelink Relay solution), an IAB-node mounted on a vehicle is expected to have better RF/antenna capabilities, and to have less stringent power/battery constraints than a relay UE.

For a mobile IAB-node it may be worth performing multiple MT migrations or DU migration, as the connection to a parent IAB-node belonging to a first IAB topology may not occur again for a long time as the mobile IAB-node moves around or never again in the case where the mobile IAB-node moves away from the parent IAB-node. Besides, for flexible IAB network management, MT and DU migration should be decorrelated, meaning that a DU migration for an IAB-node may occur before or after one or several MT migrations of this IAB-node. Moreover, the DU migration for an IAB-node may be performed toward an IAB-donor different to the IAB-donor associated to the MT of this IAB-node.

Therefore, some new mechanisms are required to provide such flexibility by supporting the DU migration of an IAB-node toward any other donor-CU, decorrelated to the MT migration(s) of the IAB-node.

### SUMMARY

In accordance with a first aspect of the present invention, there is provided a method for use in a migration process in which a Distributed Unit, DU, of an Integrated Access Backhaul, IAB, node is migrated from one IAB topology managed by a source IAB donor Central Unit, CU, to another IAB topology managed by a target IAB donor CU, the method at the source IAB donor CU comprising: determining the DU of the IAB node is to be migrated from the one IAB topology of the source IAB donor CU to the another IAB topology of the target IAB donor CU; sending, to the IAB node, a request for establishing a F1 connection between the IAB node and the target IAB donor CU.

In accordance with a second aspect of the present invention, there is provided a method, performed at an IAB node, for use in a migration process in which a DU of the IAB node is migrated from one IAB topology managed by a source IAB donor Central Unit, CU, to another IAB topology managed by a target IAB donor CU, as recited in the accompanying claims.

In accordance with a third aspect of the present invention, there is provided a method, performed at a target IAB donor CU, for use in a migration process in which a DU of an IAB node is migrated from one IAB topology managed by a source IAB donor Central Unit, CU, to another IAB topology managed by the target IAB donor CU, as recited in the accompanying claims.

Thus, by sending a request to the IAB node for establishing a F1 connection between the IAB node and the target IAB donor CU, the source F1 donor CU (e.g. source IAB donor CU) facilitates DU migration of an IAB-node with or without (multiple) MT migration(s).

Furthermore, in response to receiving the request to establish a F1 connection, the IAB node can identify (e.g. via identification information sent by the source donor CU or when no identification information is sent by the source donor CU, by determining a non-F1 donor CU is the target donor CU) the target donor CU to enable the handover of UEs served by the IAB-node to the target donor CU. The non-F1 (terminating) donor CU is also known as a RRC (terminating) donor CU.

In accordance with a fourth aspect of the present invention, there is provided an apparatus for an IAB node for an IAB communication system as recited in the accompanying claims.

In accordance with a fifth aspect of the present invention, there is provided an apparatus for an IAB donor CU (e.g. a source IAB donor CU or a target IAB donor CU) for an IAB communication system as recited in the accompanying claims.

In accordance with another aspect, there is provided a method for use in a migration process in which a Distributed Unit, DU, of an Integrated Access Backhaul, IAB, node is migrated from one IAB topology managed by a source IAB donor Central Unit, CU, to another IAB topology managed by a target IAB donor CU, the method comprising:

determining, by the source IAB donor CU, the DU of the IAB node is to be migrated from the one IAB topology of the source IAB donor CU to the another IAB topology of the target IAB donor CU; sending, by the source IAB donor CU to the IAB node, a request for establishing a F1 connection between the IAB node and the target IAB donor CU; after receiving the request for establishing a F1 connection, sending, by the IAB node to the target IAB donor CU, a F1 setup request for requesting set up of the F1 connection; after receiving, from the IAB node, the F1 setup request for requesting set up of the F1 connection, sending, by the target IAB donor CU to the IAB node, a response, the response including a request for one or more cells to be activated for a second logical DU entity of the IAB node.

Further example features of the invention are described in other independent and dependent claims.

In the following reference will be made to source and target with respect to different elements, such as nodes/topologies. It will however be appreciated that instead the terms first and second could be used in place of source and target.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram of a communication system in which the present invention may be implemented according to one or more embodiments;

FIGS. 2a and 2b schematically illustrate stacks of some protocol layers involved into IAB operations;

FIG. 3 is a schematic diagram illustrating the format of a BAP Protocol Data Unit (PDU) or packet;

FIG. 4 is a block schematic diagram of an example wireless communication device in accordance with embodiments of the present invention;

FIG. 5 is a schematic diagram of an example IAB communication system (or IAB network system) in which embodiments and examples of embodiments of the present invention may be implemented;

FIG. 6 is a schematic and simplified diagram illustrating an example of IAB-node architecture enabling its DU migration from a source IAB topology to a target IAB topology;

FIG. 7 is a simplified diagram illustrating example message flows, according to one or more embodiments of the invention, to perform DU migration of an IAB-node including the handover of UEs served by the migrating IAB-node;

FIG. 8a is a simplified diagram illustrating an example message flow of a procedure to perform the activation of a logical DU according to one or more embodiments of the invention;

FIG. 8b is a simplified diagram illustrating an example message flow of a procedure to setup a logical DU;

FIG. 8c is a simplified diagram illustrating an example message flow of a procedure to remove a logical DU;

FIG. 8d is a simplified diagram illustrating an example message flow of a procedure used by a logical DU to inform a RAN node CU about a change of configuration;

FIG. 9a is a simplified diagram illustrating an example message flow of a procedure used by a RAN node CU to report the activation of cell(s) to another RAN node CU;

FIG. 9b is a simplified diagram illustrating an example message flow of a procedure used by a RAN node CU to manage the transport migration in coordination with another RAN node CU;

FIG. 10a is a flowchart of an example method in accordance with embodiments of the present invention, for managing, at the source F1 terminating donor-CU of an IAB-node, the DU migration of the IAB-node toward a target IAB topology;

FIG. 10b is a flowchart of an example method in accordance with embodiments of the present invention, for managing, at an IAB-node, the DU migration toward a target IAB topology;

FIG. 10c is a flowchart showing example steps, in accordance with one or more embodiments of the invention, performed at an IAB-node to identify the target IAB donor CU;

FIG. 10d is a flowchart of an example method in accordance with embodiments of the present invention, for managing, at a target IAB donor CU, the DU migration of an IAB-node toward a target IAB topology managed by the target IAB donor CU.

### DETAILED DESCRIPTION

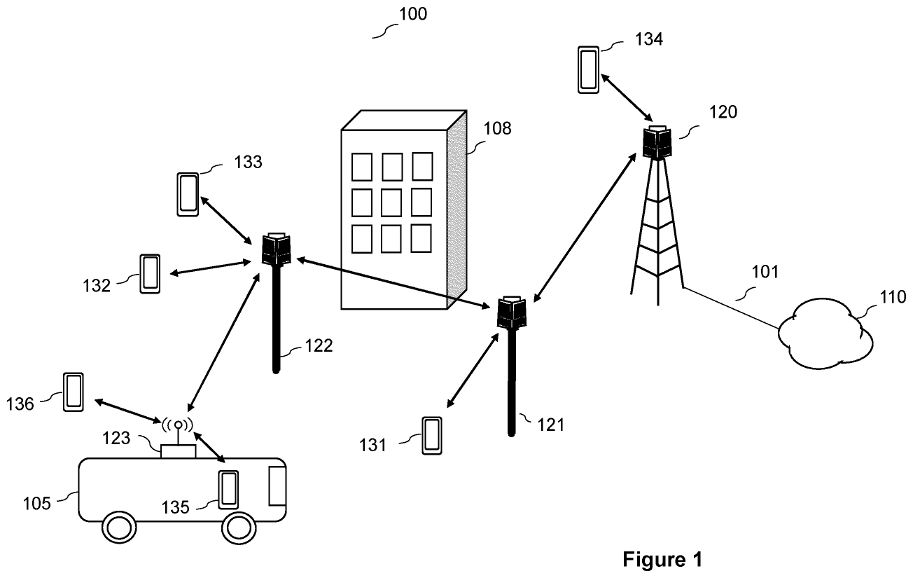

FIG. 1 illustrates an example communication system 100, in particular a mobile radio communication system such as a fifth-generation (5G) New Radio (NR) system including a wireless Integrated Access and Backhaul network supporting mobile IAB-node(s). Although in the following description, embodiments and examples of embodiments of the present invention will be described with respect to a 5G NR system, it will be appreciated that it is not intended that the present invention is limited to 5G NR systems and may be used in any wireless communication systems having a mobile base station. In particular, the following description predominantly uses terminology specific to 5G, but it should be appreciated that such terminology also applies to elements or processes performing an equivalent function in other communication systems.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes), and a mobile Integrated Access and Backhaul (IAB) station 123 mounted on a vehicle 105 (for example, a bus, a train, a taxi, a car, etc.).

The main Base Station 120, also referred to as the IAB-donor 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v17.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The mobile IAB station 123, also referred to as mobile IAB-node 123 or mIAB node 123, is an IAB-node that is mounted on vehicle 105 and provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121, 122 and 123 are thus forming a backhaul network or IAB network, or IAB topology, which accommodates UEs 132, 133, 131, 134, 135 and 136. The terms IAB network and IAB topology will be used interchangeably in the following.

The specification of the Integrated Access and Backhaul (IAB) is spread over several 3GPP standard documents, including:
TS 38.300 RAN architecture (V17.2.0),
TS 38.321 MAC protocol (V17.2.0),
TS 38.331 Radio Resource Control (RRC) protocol (V17.2.0),
TS 38.340 Backhaul Adaptation Protocol Layer (V17.2.0),
TS 38.401 RAN architecture (V17.2.0),
TS 38.423 Xn Application Protocol (V17.2.0),
TS 38.473 F1 Application Protocol (V17.2.0).

As IAB-donor 120 and IAB-nodes 121, 122 and 123 are respectively connected to UEs 134, 131, 132, 133, 135 and 136, they are considered as Access IAB-nodes for their respectively connected UEs.

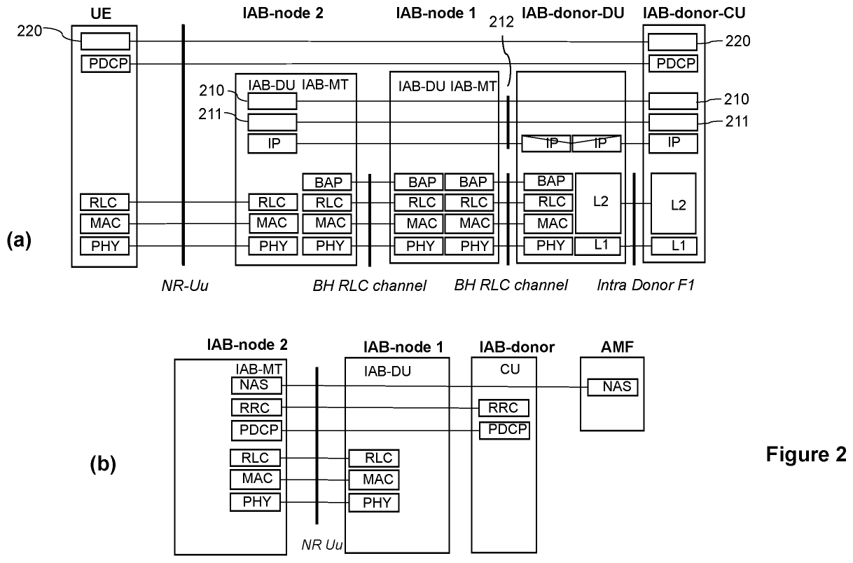

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor-CU (also referred to in the following as IAB-donor CU or IAB donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU or IAB donor DU) includes lower layer protocols, such as the RLC, MAC and physical layer protocols. The IAB-donor-CU or donor-CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes, which may serve multiple radio sectors, are wireless backhauled to the IAB-donor 120, via one or multiple hops over one or more intermediate IAB nodes. They form a directed acyclic graph (DAG) topology with the IAB-donor at its root.

The IAB nodes each consist of an IAB-DU (IAB-Distributed Unit) and an IAB-MT (IAB-Mobile Termination). The gNB-DU functionality on an IAB-node is also referred to as IAB-DU and allows the downstream (toward the UE) connection to the next-hop IAB or to a UE. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node.

The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information (e.g. control traffic) between the endpoints, as well as the data transmission (e.g. user traffic transmission) to the respective endpoints. From a logical standpoint, F1 interface is a point-to-point interface between the endpoints.

In 5G NR, F1-C is the functional interface in the Control Plane (CP) between the IAB-donor -CU and an IAB-node -DU (e.g. of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor-CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor-CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS 38.473 and TS 38.401) provides signalling services between the IAB-donor-CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor-CU and the IAB-node DU as defined in 3GPP TS 38.401.

The transport between the IAB-donor DU and the IAB-donor-CU also uses an IP transport Layer over various media, like for example wires or optical fiber when the IAB-donor-CU is remote from the IAB-donor DU, or locally in a virtual instantiation of the IAB-donor-CU and the IAB-donor DU on the same physical machine. IAB-specific transport between IAB-donor-CU and IAB-donor-DU is specified in 3GPP TS 38.401.

L1 and L2 on the FIG. 2a stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

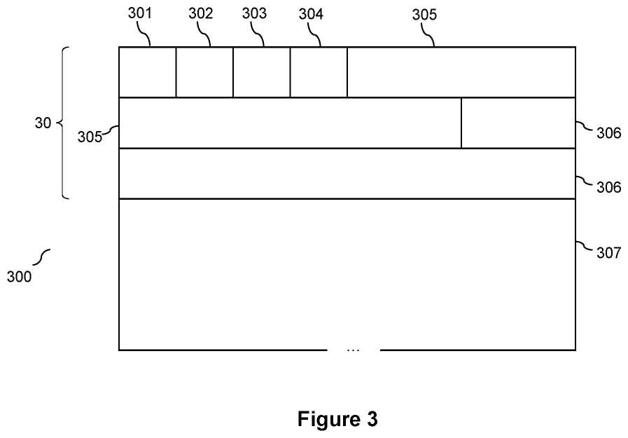

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS 38.340 release 17.2.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU in an IAB network is configured (by IAB-donor-CU of the IAB network) with a designated and unique BAP address. Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes of the IAB network.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e. either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY sublayer, deletes its header and passes the remaining data to the RLC. The PHY sublayer provides an electrical interface to the transmission medium (the air) by converting the stream of information into physical modulation signals, modulating a carrier frequency at emitter side. At the receiver side, the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS 38.323.

SDAP sublayer 220 for the User Plane handles the Quality of Service. It is described in TS38.324. On the UE side, the SDAP sublayer exchanges the payload data with the user's application (voice, video, etc . . . —not shown in the Figure). On the IAB-donor-CU side, the SDAP sublayer exchanges the data with the Core Network 110 (Internet traffic, Cloud, etc. . . . ).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v17.2.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

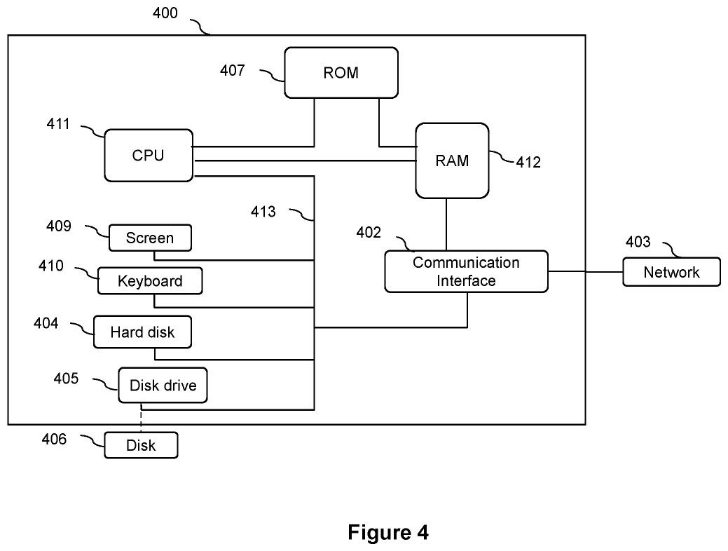

FIG. 4 shows a schematic representation of an example communication device (apparatus) or station, in accordance with one or more example embodiments of the present disclosure.

The communication device 400 may be a device such as a micro-computer, a workstation or a light portable device. The communication device 400 may comprise a communication bus 413 to which there are preferably connected:
a central processing unit 411, such as a microprocessor, denoted CPU. The central processing unit 411 may be a single processing unit or processor or may comprise two or more processing units or processors carrying out the processing required for the operation of the communication device 400. The number of processors and the allocation of processing functions to the central processing unit 411 is a matter of design choice for a skilled person;
memory for storing data and computer programs containing instructions for the operation of the communication device 400. The computer programs may contain a number of different program elements (modules) or sub-routines containing instructions for a variety of operations and for implementing the methods in accordance with one or more embodiments of the invention; and
at least one communication interface 402 for communicating with other devices or nodes in a communication system, such as the communication system of FIG. 1. The at least one communication interface 402 may be connected to the radio communication network 403, such as a wireless communication network for 5G NR (e.g. according to release 17 and/or subsequent releases), over which digital data packets or frames or control frames are transmitted. The frames are written from a FIFO sending memory in RAM 412 to the communication interface for transmission or are read from the communication interface for reception and writing into a FIFO receiving memory in RAM 412 under the control of a software application running in the CPU 411.

Each of a donor CU, a donor DU, an IAB node and a UE may be implemented in such a communication device/apparatus 100.

The memory may include:
a read only memory 407, denoted ROM, for storing computer programs for implementing methods in accordance with one or more embodiments of the invention;
a random-access memory 412, denoted RAM, for storing the executable code of methods according to one or more embodiments of the invention as well as the registers adapted to record variables and parameters necessary for implementing methods according to one or more embodiments of the invention.

Optionally, the communication device 400 may also include the following components:
a data storage means 404 such as a hard disk, for storing computer programs for implementing methods according to one or more embodiments of the invention;
a disk drive 405 for a disk 406, the disk drive being adapted to read data from the disk 1106 or to write data onto said disk;
a screen 409 for displaying decoded data and/or serving as a graphical interface with the user, by means of a keyboard 410 or any other input/output means.

In an example arrangement, the communication bus 413 provides communication and interoperability between the various elements included in the communication device 400 or connected to it. The representation of the bus is not limiting and in particular, the central processing unit is operable to communicate instructions to any element of the communication device 400 directly or by means of another element of the communication device 400.

The disk 406 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables a method according to embodiments of the invention to be implemented.

The executable code may optionally be stored either in read only memory 407, on the hard disk 404 or on a removable digital medium such as for example a disk 406 as described previously. According to an optional variant, the executable code of the programs can be received by means of the communication network 403, via the interface 402, in order to be stored in one of the storage means of the communication device 400, such as the hard disk 404, before being executed.

The central processing unit 411 may be adapted to control and direct the execution of the instructions or portions of software code of the program or programs according to the invention, which instructions are stored in one of the aforementioned storage means. On powering up, the program or programs that are stored in a non-volatile memory, for example on the hard disk 404 or in the read only memory 407, are transferred into the random-access memory 412, which then contains the executable code of the program or programs, as well as registers for storing the variables and parameters necessary for implementing the invention.

In an example implementation, the communication device (apparatus) is a programmable device/apparatus which uses software to implement the invention. Instructions may be executed by one or more processors of the apparatus, such as one or more digital signal processors (DSPs), general purpose microprocessors, application specific integrated circuits (ASICs), field programmable logic arrays (FPGAs), or other equivalent integrated or discrete logic circuitry to implement the invention for a network node (e.g. IAB node, IAB donor CU). Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

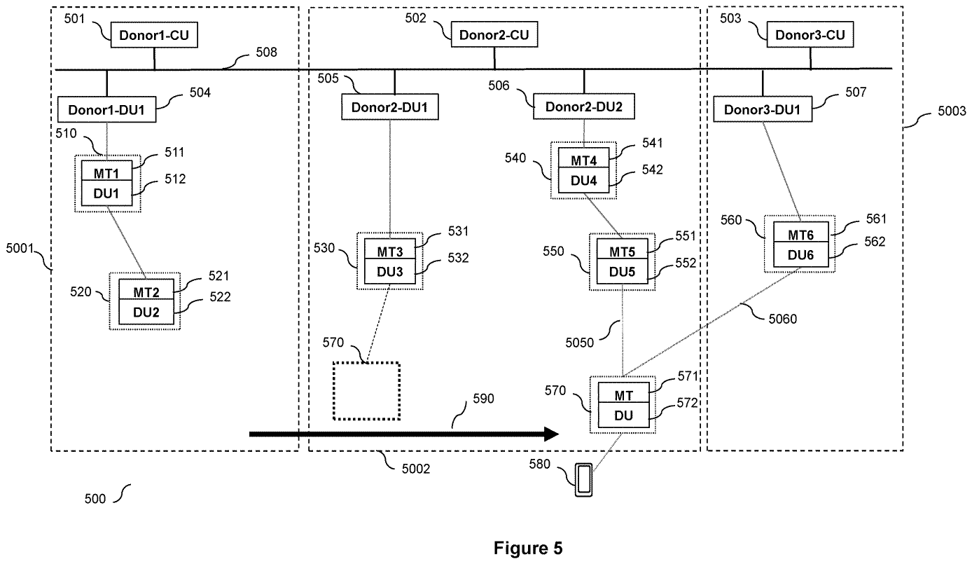

FIG. 5 illustrates an example of an IAB communication system (or IAB network system) 500 in which embodiments and examples of embodiments of the present invention may be implemented. In one example implementation, the radio links between the IAB nodes and between the IAB nodes and the IAB donor DUs (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

IAB communication system 500 is composed of three IAB networks or IAB topologies 5001, 5002, and 5003 with each IAB topology comprising a set of IAB nodes (e.g. the set may comprise a plurality of IAB nodes or at least one IAB node) and an IAB-donor-CU for controlling or managing the plurality of IAB nodes. The set of IAB nodes may include one or more IAB-nodes, such as initiator IAB-nodes which generate BAP packets and also intermediate or relay IAB-nodes. Each of the IAB nodes communicate with at least one other IAB node over a wireless backhaul (BH) link. Although FIG. 5 shows three IAB topologies 5001, 5002, and 5003, the present invention is not limited to three IAB topologies and may be implemented in an IAB communication system comprising more than two IAB topologies with each topology comprising a set of IAB nodes and an IAB donor-CU as discussed above.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 510 comprises a MT part or unit 511 and a DU part 512.

IAB topology 5001 includes IAB-donor-CU 501 (identified as Donor1-CU in FIG. 5), and its associated IAB-donor-DU 504 (identified as Donor1-DU1 in FIG. 5), and a plurality of IAB-nodes 510 and 520, similar to IAB-nodes 121 and 122.

IAB topology 5002 includes IAB-donor-CU 502 (identified as Donor2-CU in FIG. 5), its associated IAB-donor-DUs, IAB-donor-DU 505 (identified as Donor2-DU1 in FIG. 5) and IAB-donor-DU 506 (identified as Donor2-DU2 in FIG. 5), and a plurality of IAB-nodes 530, 540, 550, similar to IAB-nodes 121 and 122, and IAB-node 570, that may be similar to mobile IAB-node 123. All IAB-nodes can be access nodes serving UEs like the UE 580 served by the mobile IAB-node 570. The IAB topology 5002 is transparent for the UE 580 that connects to the donor-CU 502 through the DU part or unit 572 of the mobile IAB-node 570. Although FIG. 5 shows only one UE 580, it will be appreciated that there will be a plurality of UEs connected to the network nodes of the IAB communication system 500.

IAB topology 5003 includes IAB-donor-CU 503 (identified as Donor3-CU in FIG. 5), and its associated IAB-donor-DU 507 (identified as Donor3-DU1 in FIG. 5), and an IAB-node 560, similar to IAB-nodes 121 and 122.

A wired backhaul IP network interconnects the IAB-donor-CUs 501, 502, and 503, and the IAB-donor-DUs 504, 505, 506 and 507 through the wired backhaul 508. For instance, this wired backhaul 508 consists of optical fiber cables.

IAB-Donor-CU 501, IAB-Donor-DU 504 and IAB-nodes 510 and 520 are part of the same IAB network or IAB topology 5001, which is configured and managed or controlled by IAB-Donor-CU 501.

IAB-Donor-CU 502, IAB-Donor-DUs 505 and 506, and IAB-nodes 530, 540, 550 are part of the same IAB network or IAB topology 5002, which is configured and managed or controlled by IAB-Donor-CU 502.

IAB-Donor-CU 503, IAB-Donor-DU 507, and IAB-node 560 are part of the same IAB network or IAB topology 5003, which is configured and managed or controlled by IAB-Donor-CU 803.

Each IAB-DU and IAB Donor DU supports wireless communication in a coverage area(s) referred to as cell(s) (not shown in FIG. 5). In other words, each IAB-DU and IAB Donor DU is associated with cell(s). Wireless communication devices (such as UEs, or other IAB-nodes) located within a cell may establish communication links with the node (i.e. IAB-DU or IAB Donor DU) serving the cell in order to communicate with other devices (e.g. other UEs, IAB-nodes, servers providing access to the Internet, etc.) via the node.

It is assumed that the mobile IAB-node 570 had initially a single parent IAB-node 520, and that IAB-node 570 belongs to the IAB topology 5001 controlled by the IAB-Donor-CU 501. The IAB-Donor-CU is thus operating as the F1 terminating donor-CU (which may also be referred to as a F1-terminating IAB-donor-CU or F1 donor-CU). When moving, and in view of its proximity to IAB topology 5002, in particular to the IAB-node 530 when the mobile IAB-node 570 is in the position shown in dotted lines in FIG. 5, the mobile IAB-node 570 may be able to establish a wireless BH link with the IAB-node 530. Such a BH link is possible for a stationary IAB-node, and it is very likely to happen for a mobile IAB-node like IAB-node 570, moving, for instance, in the direction of the IAB topology 5002 (shown by arrow 590 in FIG. 5.

Then, the F1 donor-CU 501 may have decided to perform the migration of the MT part 571 of the IAB-node 570 toward the IAB topology controlled by the donor-CU 502, which became the non-F1 terminating donor-CU (which may also be referred to as a non-F1-terminating IAB-donor-CU or non-F1 donor-CU or RRC terminating donor-CU or RRC donor-CU) for the IAB-node 570 (i.e. the MT part 571 of the IAB-node 570 is migrated toward the parent IAB-node 530). For this purpose, the F1 donor-CU 501 may have initiated the inter-CU Topology Adaptation procedure described in TS 38.401 V17.2.0 section 8.17.3.1 or section 8.17.3.2 (when the IAB-node 570 has descendant IAB-nodes). As a result, the IAB-node 501 still belongs to the IAB topology 5001, with its F1 connection to the donor-CU 501, but its RRC connection is now to the donor-CU2 502. After that procedure, the IAB-donor-CU 501 may request the migration toward the IAB topology 5002 (i.e. through the donor-DU 505) of the backhaul traffic (e.g. user traffic, control traffic) related to the IAB-node 570. In this case, the donor-CU 501 triggers the IAB transport migration management procedure specified in TS 38.423 V17.2.0 section 8.5.2. In the IAB communication system, all traffic communicated over backhaul links uses a F1 interface (F1-C or F1-U) between an IAB donor CU and an IAB-DU. Thus, the traffic or backhaul traffic that is offloaded or migrated is F1 traffic and can include control and user traffic.

While the mobile IAB-node 870 is still moving in the direction shown by arrow 590, the MT part 571 of the IAB-node 570 may then have been migrated by the non-F1 donor-CU 502 toward the parent IAB-node 550, using the backhaul link 5050 between the IAB-node 550 and the IAB-node 570. For this purpose, the non-F1 donor-CU 502 may have applied the intra-CU topology adaptation procedure described in TS 38.401 V17.2.0 section 8.2.3.1 (or section 8.17.3.2), resulting in a consecutive MT migration (or another MT migration to another IAB-node) of the IAB-node 570 with a new single parent IAB-node 550. Still, the IAB-node 501 has its F1 connection with the donor-CU 501 and its RRC connection with the donor-CU2 502.

After being informed to use the donor-DU 506 instead of donor-DU 505 to route the F1 traffic related to the IAB-node 570, the donor-CU 501 may request the migration of the traffic related to the IAB-node 570 toward the IAB topology 5002. In this case, the donor-CU 501 triggers the IAB transport migration management procedure specified in TS 38.423 V17.2.0 section 8.5.2.

While further moving, this time in the direction of IAB topology 5003 controlled by the donor-CU 503, the IAB-node 570 may become in a position where a backhaul link 5060 with the IAB-node 560 may have a better quality than the backhaul link 5050 with the IAB-node 550. Thus, the donor-CU 502 may apply the inter-CU Topology Adaptation procedure described in TS 38.401 V17.2.0 section 8.17.3.1 or 8.17.3.2. After this consecutive MT migration, the IAB-node 501 still belongs to the IAB topology 5001, with its F1 connection with the donor-CU 501, but its RRC connection is now with the donor-CU 503 and thus, the donor-CU 503 becomes the non-F1 terminating donor-CU (or non-F1 donor-CU or RRC donor-CU). However, the donor-CU 501 has to be informed of the new non-F1 donor-CU 503 for the IAB-node 570 and of the new donor-DU 507 to redirect the offloaded traffic (F1 traffic, control and user traffic) through the donor-DU 507 instead of donor-DU 506.

In all the MT migration cases described above, the UE 580 still connects to the donor-CU 501 through the DU part or unit 572 of the mobile IAB-node 570. In case the IAB-node 570 has some child IAB-node(s), such child IAB-node still belongs to the IAB topology 5001, and it is still fully controlled (through F1 and RRC connections) by the donor-CU 501. At any state of migration of the MT part 571 of the IAB-node 570, thus regardless of whether the MT part 571 of the IAB-node 570 has migrated to IAB topology 5002 or IAB topology 5003 and so regardless of whether the IAB-node 570 has a non-F1 terminating donor-CU and if it does, whether it's the non-F1 terminating donor-CU 502 or 503, the F1 donor-CU 501 may decide to perform the migration of the DU part of the IAB-node 570. The reason for performing DU migration may be to reduce the processing load at the F1 donor-CU 501, or because the IAB-node 570 is geographically far from the F1 donor CU 501 and close to an area where there is no more Xn connectivity between the F1 donor CU 501 and a target donor-CU. After the decision to perform the DU migration of the IAB-node 570, the F1 donor-CU 501 has also to decide toward which donor-CU (which is referred to as the target F1 donor-CU) the DU migration shall be performed. It may be a DU migration toward the current non-F1 terminating donor-CU (i.e. the default choice) if there is a current non-F1 terminating donor-CU and in this case the non-F1 terminating donor-CU becomes the target F1 donor-CU, or to another target F1 donor-CU. For instance, if the IAB-node 570 is mobile and its trajectory is predictable (e.g. for a bus or a train), the F1 donor-CU 501 may be aware of a suitable target F1-donor-CU controlling cells through which the IAB-node 570 will soon connect to the network. For instance, while the non-F1 terminating donor-CU of the IAB-node 570 is the donor-CU 502, the F1 donor-CU may decide the DU migration of the IAB-node 570 should be directly toward the donor-CU 503, as the IAB-node 570 may rapidly cross and not stay in the IAB topology 5002 controlled by the donor-CU 502. To not perform the DU migration toward the donor-CU 502, and instead perform DU migration toward the donor-CU 503, will avoid protocol messages for the intermediate DU migration of the IAB-node 570. When DU migration is performed, handover of the UEs served by the IAB-node 570 must also be performed. Thus, to not perform the DU migration toward the donor-CU 502 will also avoid the intermediate handover of UEs served by the IAB-node 570 to the donor-CU 502, before a new DU migration and UEs handover toward the donor-CU 503.

The procedure to perform a DU migration and the UEs handover toward a selected target F1 donor-CU is described in more detail with reference to the subsequent figures.

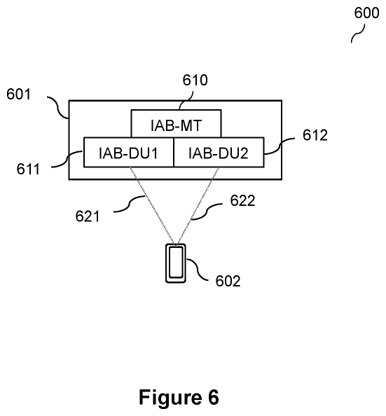

FIG. 6 illustrates an example of IAB-node architecture 600 which enables migration of the DU of the IAB-node (DU migration) from a source IAB topology to a target IAB topology.

The IAB node 601, which may be a mobile IAB-node like the IAB-node 570, is composed of an IAB-MT part or unit IAB-MT 610 (like the MT part 571 of the IAB-node 570 of FIG. 5), a part or unit IAB-DU1 611, and a part or unit IAB-DU2 612. IAB-DU1 and IAB-DU2 are two logical DU entities that share the same hardware for the BAP, RLC, and MAC layers. In one example, they share the same physical layer (i.e. the same hardware resources), while in another example they rely on separated physical layers. At the DU migration of the IAB-node 601, both logical DUs are active: one of the logical DU terminates the F1 interface with a source F1 donor-CU (like donor-CU 501 in FIG. 5), while the other logical DU terminates the F1 interface with a target F1 donor-CU (like donor-CU 502 or 503 in FIG. 5). Otherwise (i.e. when DU migration is not to be performed), only one logical DU is sufficient for IAB operations. As an example and with reference to the IAB communication system of FIG. 5, the F1 terminating donor CU of the IAB node 601 (i.e. IAB node 570) may be donor-CU 501 which is thus operating as the source F1 donor-CU. The source F1-donor CU 501 may identify IAB donor-CU 502 as a suitable target F1 donor-CU when the source F1-donor CU 501 determines that the IAB-node 570 is moving towards/through the IAB topology 5002 which includes network nodes (e.g. IAB donor DUs 505, 506, IAB nodes 530, 540, 550) managed by the IAB donor-CU 502, which network nodes serve cells in IAB topology 5002 to which the IAB-node 570 will soon connect. Alternatively, for an IAB node which is connected to parent IAB-node or parent IAB donor-DU of the IAB topology 5001 managed by the donor-CU 501 as the F1 terminating donor CU and which is stationary but is in proximity to or in the vicinity of one or more IAB nodes in a neighbouring IAB topology, such as IAB topology 5002, the source F1-donor CU 501 may determine that IAB donor-CU 502 is a suitable target F1 donor-CU when source F1-donor CU 501 determines (e.g. based on signal measurements performed at the IAB-node on radio signals received at the IAB-node from all IAB-nodes in proximity to the IAB-node and which may include IAB-nodes in the neighbouring IAB topology 5002) that the IAB-node may soon connect to an IAB-node in the neighbouring IAB topology 5002.

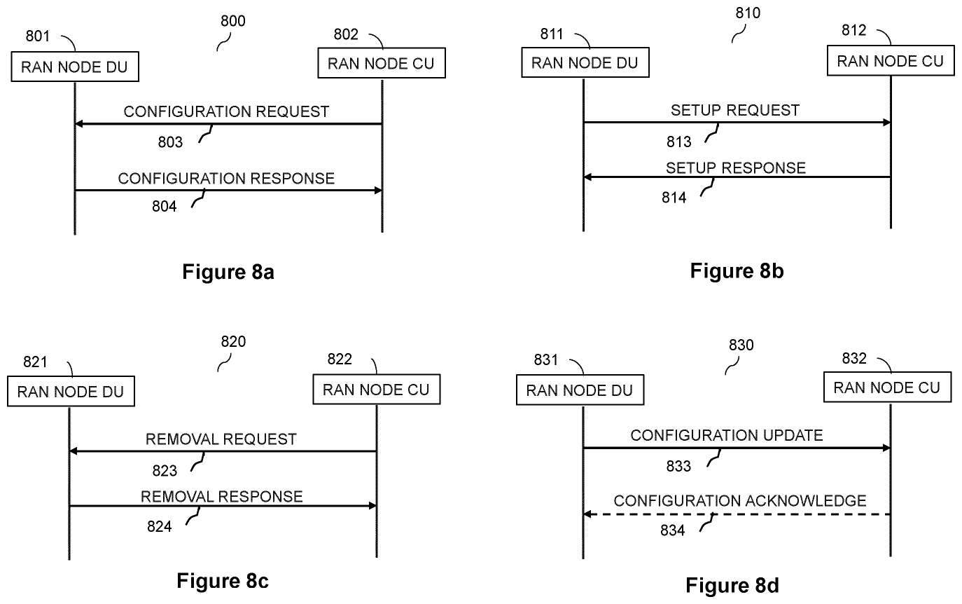

Before the DU migration, a UE 602 (like UE 580 of FIG. 5) is for instance connected to the source F1 donor-CU 501 through the logical DU IAB-DU1 611 with the access link 621 in the cell served by the logical DU IAB-DU1 611, and the logical DU IAB-DU2 612 is deactivated. At the DU migration, the logical DU IAB-DU2 612 is activated and connects to the target F1 donor-CU 502, to which the UE 602 may also connect through the logical DU IAB-DU2 612 with the link 622 in the cell served by the logical DU IAB-DU2 612. The activation of the logical DU IAB-DU2 612 may be triggered by the source F1 donor-CU and executed with the procedures described with reference to the FIGS. 8a and 8b. Once the handover of UE 602 is completed from a cell controlled by the logical DU IAB-DU1 611 to a cell controlled by the logical DU IAB-DU2 612, the logical DU IAB-DU1 611 may be deactivated. The deactivation may be triggered by the source F1 donor-CU 501 with the procedure described with reference to FIG. 8c, after the detection of the completion of the handover for all UEs served by the IAB-DU1 611.

Examples of methods, in accordance with one or more embodiments of the present invention, which enable DU migration of an IAB-node to be performed, with or without (multiple) MT migration(s), and which include notifying the IAB-node about the identity of target donor CU to enable the handover of UEs served by the IAB-node to the target donor CU will now be described. Although the following methods/apparatus' will be described primarily with respect to a mobile IAB node, it will be appreciated that it is not intended that the invention is limited to mobile IAB nodes. The methods in accordance with one or more embodiments of the present invention may apply to stationary IAB nodes e.g. that are at the edge of one IAB topology and in the proximity of or in the vicinity of one or more IAB nodes in a neighbouring IAB topology.

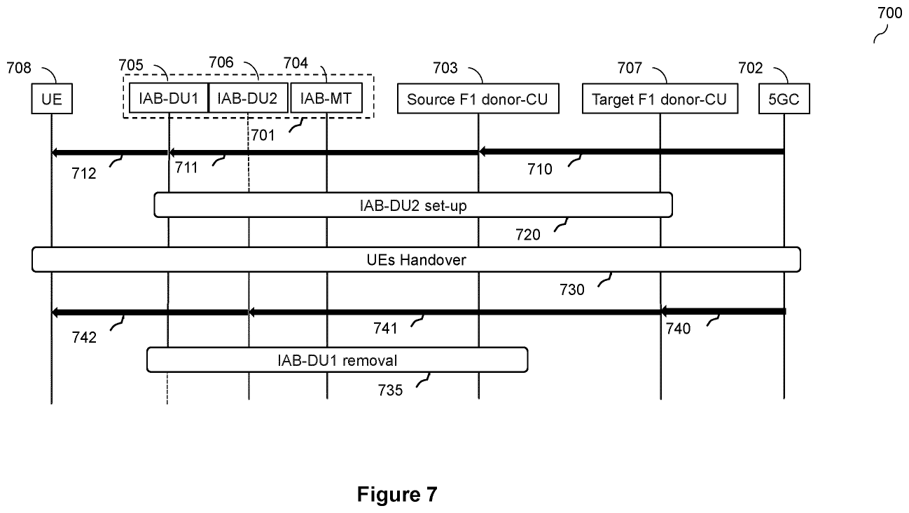

FIG. 7 is a schematic and simplified diagram 700 illustrating some example message flows according to one or more embodiments of the invention, to perform the DU migration of an IAB-node, with or without (multiple) MT migration(s), and which includes informing the IAB-node about the target donor CU to enable the handover of UEs, served by the migrating IAB-node, to the target donor CU.

This FIG. 7 shows a UE 708 like the UE 580, a source F1 donor-CU 703 like the donor-CU 501, a target F1 donor-CU 707 like the donor-CU 503, the core network (5GC) 702 like the core network 110 of FIG. 1. This FIG. 7 also shows an IAB-node 701 that may be a mobile IAB-node like the IAB-node 570 composed of a MT part or unit IAB-MT 704, a DU part or unit IAB-DU1 705 (e.g. source or first logical DU entity), and a DU part or unit IAB-DU2 706 (e.g. target or second logical DU entity). Each of the first 705 and second 706 DU logical entities serve one or more cells. The cell(s) of the IAB-DU1 705 are identified by different identifiers (e.g. Physical Cell Identifier (PCI), New Radio Cell Group Identifier (NCGI)) to the cell(s) of the IAB-DU1 705. IAB-DU1 705 and IAB-DU2 706 are two logical DU entities that share the same hardware for the BAP, RLC, and MAC layers. In one example, they share the same physical layer (i.e. the same hardware resources), while in another example they rely on separated physical layers. The non-F1 donor-CU for the IAB-node 701 may be the source F1 donor-CU 703 itself if the IAB-MT 704 was not migrated.

The non-F1 donor-CU for the IAB-node 701 may be the target F1 donor-CU 707 if the IAB-MT 704 was previously migrated toward the target F1 donor-CU 707, or another donor-CU (not represented in the figure) if the IAB-MT 704 was previously migrated toward this other donor-CU.

At the beginning of the flow, the IAB-node 701 belongs to the source IAB topology controlled by the source F1 donor-CU 703. The UE 708 is served by the IAB-node 701 through a cell of IAB-DU1 705 (e.g. the DU of the IAB-node 701 has an active IAB-DU1 705 having a F1 connection with the source F1 IAB donor CU 703), while the logical IAB-DU2 706 is inactive. The user data in the downstream direction are provided by the 5GC 702 to the source F1 donor-CU 703 through the bearer 710, then the data are transmitted to the logical DU IAB-DU1 705 of the IAB-node 701 through the backhaul bearer 711, and finally to the UE 708 through the data radio bearer 712. The backhaul bearer 711 may be established in the source IAB topology controlled by the source F1 donor-CU 703, or in the IAB topology controlled by the non-F1 donor-CU of the IAB-node 701 (if the IAB-MT 704 was previously migrated toward this non-F1 donor-CU). User data in the upstream direction (not represented in the figure) are transmitted through similar bearers in the opposite direction.

The IAB-MT 704 may send measurement reports (not represented in the FIG. 7) to its non-F1 terminating donor-CU if it has been previously migrated toward this non-F1 donor-CU (not shown in FIG. 7) or if it has not been migrated from its F1 terminating donor-CU, to its F1 terminating donor-CU (e.g. source F1 donor-CU 703), as the result of the measurements regularly performed by IAB-MT 704 on signals received from the serving cell and one or more target cells, such as the Signal Synchronization Block (SSB) transmitted in the serving cell and in the target cells. The target cells may be neighbouring cells to the serving or source cell (i.e. the current serving cell). Once the IAB-MT 704 discovers at least one SSB that meets predefined criteria (for instance a received power that exceeds a predefined threshold), a measurement report may be generated and transmitted to provide radio link quality information for different cells in the vicinity of the IAB-node 701. The identity of each cell is included in the measurement report to allow the non-F1 donor-CU if the IAB-MT 704 has been migrated, or F1 terminating donor-CU 703 if the IAB-MT 704 has not been migrated, to identify the target donor CU associated with the cell. Indeed, the identification of a donor-CU can be deduced from the Physical Cell identity (PCI) broadcasted in each cell managed by this donor-CU in a synchronization signal, and/or from the New Radio Cell Group Identifier (NCGI) also broadcasted in each cell managed by this donor-CU in a System Information Block (SIB) message. The PCI and/or the NCGI may be reported by the IAB-node 701 in the measurement report.

Based on the received measurement reports, the non-F1 donor-CU if the IAB-MT 704 has been migrated, or F1 terminating donor-CU 703 if the IAB-MT 704 has not been migrated, may detect that the IAB-node 701 receives radio signals in a target cell of a target parent IAB-node with a better quality than in the source serving cell. The non-F1 donor-CU if the IAB-MT 704 has been migrated, or F1 terminating donor-CU 703 if the IAB-MT 704 has not been migrated, may decide to apply a procedure to perform the IAB-MT 704 migration toward a target parent IAB node that belongs either to the same IAB topology (intra-CU topology adaptation), or to another IAB topology (inter-CU topology adaptation). In any case, the source F1 donor-CU 703 will be informed about this MT migration by the non-F1 donor-CU if the IAB-MT 704 has been migrated or the source F1 donor-CU 703 will be informed since it made the decision to perform MT migration directly from the measurement reports received from the IAB-node 701 if the IAB-MT 704 has not been migrated, and this information may be used by the source F1 donor-CU 703 to trigger a DU migration of the IAB-node 701. In another example, the non-F1 donor-CU may relay the information in the measurement reports received from the IAB-node 701 to the source F1 donor-CU 703. Thus, the source F1 donor-CU 703 may base its decision for DU migration of the IAB-node 701 directly from these measurement reports relayed by the non-F1 donor-CU.

Thus, the source F1 donor-CU 703 determines the DU of the IAB node is to be migrated from the IAB topology of the source F1 donor-CU 703 to another IAB topology of a target IAB donor CU. The determination may be based on determining that a migration of a MT of the IAB node toward a new parent IAB node has been completed. Another example of a triggering event for determining the DU of the IAB node is to be migrated may include the decision for DU migration may be based on the detection of a MT migration from a first IAB topology toward a second IAB topology, and on a known (predefined) trajectory of the IAB-node that indicates to the source F1 donor-CU that the MT will be migrated later to a third IAB topology. In this case, to avoid signaling messages for DU migration/UEs handover toward the second IAB topology, the DU is directly migrated toward the third IAB topology. Another example of a triggering event for determining the DU of the IAB node is to be migrated may include the processing load level being detected above a predefined threshold in the source F1 donor-CU. Then DU migration is triggered and the choice of target F1 donor-CU is based on the processing load of other donor-CUs connected to the source F1 donor-CU.

Upon the decision of or determination by the source F1 donor-CU 703 to perform the DU migration of the IAB-node 701 toward another IAB topology managed by another donor-CU which becomes the target F1 donor-CU 707, the first step 720 corresponds to sending a request to the IAB node 701 to establish a new F1 connection between the target F1 donor-CU 707 and the mobile IAB node 701. This may require activation of the second logical IAB-DU2 706 in the mobile IAB node 701 and thus the first step 720 may include the activation of the second logical DU IAB-DU2 706 in the mobile IAB node 701. This operation is performed using, for example, the procedures described with reference to the FIGS. 8a and 8b. In particular, the message sent by the source F1 donor-CU 703 to the IAB-node 701 for the activation of the IAB-DU2 706 (e.g. 803 in FIG. 8a) may include identification information for identifying the target donor CU, such as the TNL address (i.e. IP address) of the target F1 donor-CU 707, so that a new F1 connection or F1 association (e.g. a F1AP interface connection) may be set up with the target donor CU 707 (between the IAB-DU2 706 and the target donor CU 707). If the address of the target F1 donor-CU is not included in the request for activation, then by default and in the case where the IAB-MT 704 has been migrated to a non-F1 donor-CU, the non-F1 Donor-CU is considered as the target F1 donor-CU. In this case, the IAB-node 701 has already been informed of the identity (e.g. the TNL address/IP address) of target donor-CU when the IAB-MT 704 was migrated to the non-F1 Donor-CU. In other words, the source F1 donor-CU 703 may send identification information for identifying the target IAB donor CU unless the IAB-MT 704 has been migrated to a non-F1 donor-CU. Alternatively, the source F1 donor-CU 703 may send identification information for identifying the non-F1 donor-CU as the target IAB donor CU. After determining the DU of the IAB node 701 is to be migrated and once the IAB-DU2 706 has been activated, then, the IAB-DU2 706 may send a F1 setup request message (e.g. 813 in FIG. 8b) to the target F1 donor-CU 707 for requesting set up of the F1 connection between the IAB-node 701 and the target F1 donor-CU 707. This message may include identification information for identifying the source IAB donor CU, such as the TNL address (i.e. the IP address) or the identifier (i.e. Global NG-RAN Node ID as specified in TS 38.423 V17.2.0 section 9.2.2.3) of the source F1 donor-CU 703 of the IAB-node 701. This message may also include the TNL address (i.e. the IP address) or the identifier (i.e. Global NG-RAN Node ID as specified in TS 38.423 V17.2.0 section 9.2.2.3) of the non-F1 donor-CU of the IAB-node 701 if the IAB-MT 704 of the IAB-node 701 has been previously migrated toward this non-F1 donor-CU (not shown in FIG. 7). The destination address of the F1 setup request message is the target F1 donor-CU 707, and when this IP packet is received by the donor-DU in the F1 path for the IAB-node 701, it can be routed in the wired backhaul (508 in the FIG. 5) up to the target F1 donor-CU 707. For instance, in an example where the IAB-node 701 is the IAB-node 570 of FIG. 5 which is connected to IAB-node 550 via backhaul link 5050 and where the MT (MT 571 which corresponds to IAB-MT 704 in FIG. 7) of the IAB-node 570 has been migrated to the non-F1 donor CU 502 and the IAB donor CU 501 is the source F1 donor CU, the F1 path between the FI donor CU 501 to the IAB-node 570 uses the donor-DU 506. In the case where the IAB donor CU 503 has been identified (by F1 donor CU 501) as the target F1 donor CU (e.g. target F1 donor-CU 707), the F1 setup request message for the target F1 donor-CU (for instance donor-CU 503) is sent through the IAB-nodes 550, 540 and then to the donor-DU 506 from where it can be routed in the wired backhaul (508 in the FIG. 5) up to the target F1 donor-CU 503. In the F1 setup response (e.g. 814 in FIG. 8b), the target F1 donor-CU 707 (e.g. donor-CU 503 in the example described above with reference to FIG. 5) may request the IAB-DU2 706 to activate new cell(s) with associated identifiers (PCI, NCGI). Usually the DU activates/deactivates cell(s) under the control of the donor-CU which is controlling the DU. See, for example, TS 38.473 section 8.2.3.2.

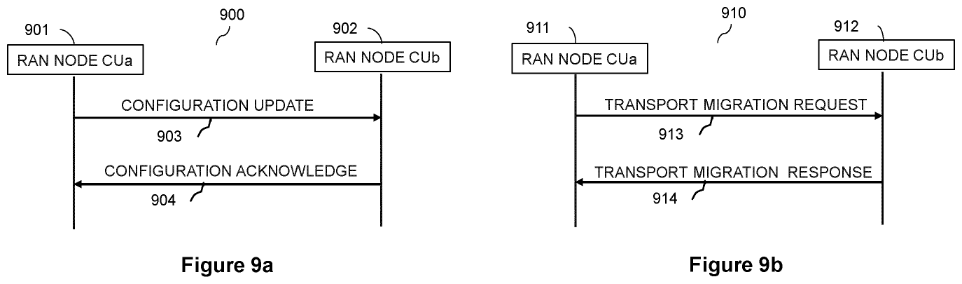

After the procedure described with reference to FIG. 8b, and using, for example, the procedure described with reference FIG. 9a, the target F1 donor-CU 707 may inform the source F1 donor-CU 705 about the activation of new cell(s) from the IAB-DU2 706 of the IAB-node 701.

The next step 730 consists in the handover of UEs (e.g. UE 708 in FIG. 7) served by the IAB node 701, from the cell(s) of the first logical DU IAB-DU1 705 to the cell(s) of the second logical DU IAB-DU2 706. This procedure may be the standardized procedure described in TS 38.300 section 9.2.3.2 (handover), or the standardized procedure described in TS 38.300 section 9.2.3.4 (conditional handover). In an example, to trigger the handover of the UE 708, the source F1 donor-CU 703 sends a HANDOVER REQUEST message to the target F1 donor-CU 707 including the necessary information related to the UE 708 to hand over (e.g. identification information identifying the UE, UE context information, such as the security context (e.g. security parameters such as security key, UE security capabilities), measurement configuration, radio configuration (e.g. UE radio capability), information about bearers, etc.). TS 38.423, section 9.1.1.1 provides details as to the content of a HANDOVER REQUEST message. After an admission control step in which the target F1 donor-CU 707 determines whether the donor-CU can accept the handover of the UE 708, when the target F1 donor-CU 707 accepts the request, the target F1 donor-CU 707 sends a handover acknowledgement message to the source F1 donor-CU 705, including configuration information for the UE 708 for the handover. The configuration may include radio configuration information indicating the radio configuration to be used by the UE 708 to connect to the second logical DU IAB-DU2 706 of the IAB node 701 in an identified target cell of the second logical DU IAB-DU2 706 (e.g. the radio configuration may include frequency, radio bearer configuration, etc.). The handover acknowledgement may include an identifier for each of the one or more new cells (e.g. the target cell(s)) that have been activated at the second logical DU IAB-DU2 706. Then, the source F1 donor-CU 705 sends this configuration information to the UE 708 via the IAB node 701 in a RRC Reconfiguration message, including the identifier of the target cell of IAB-DU2 706 to which the UE 708 is to connect. The RRC Reconfiguration message (specified in TS 38.331) is embedded in a F1 message DL RRC MESSAGE TRANSFER (specified in TS 38.473), sent to the IAB-DU1 705 and relayed by the IAB-DU1 705 to the UE 708. Upon reception of this configuration information, the UE 708 performs a random-access procedure in the indicated target cell of IAB-DU2 706 to obtain uplink resources, and then to transmit a RRC Reconfiguration Complete message to the target F1 donor-CU 707. The RRC Reconfiguration Complete message (specified in TS 38.331) is sent to the IAB-DU2 706, and then embedded in a F1 message UL RRC MESSAGE TRANSFER (specified in TS 38.473), sent to the target F1 donor-CU 707. The source F1 donor-CU 705 may be informed about the completion of the UE 708 handover through the HANDOVER SUCCESS message (specified in TS 38.423) received from the target F1 donor-CU 707.

The target F1 donor-CU 707 may perform a path switch procedure toward the core network 702 to request the delivery of the user data related to the UE 708. For example, target F1 donor-CU 707 may perform the path switch handshake procedure described in 3GPP TS 38.413 v17.2.0 section 8.4.4.

Then, the target F1 donor-CU 707 has to setup the backhaul path(s) to/from the migrated IAB-node 701, either in its own topology if there is a backhaul path to reach the IAB-node 701 in the IAB topology controlled by the target F1 donor-CU 707 (i.e. the target F1 donor-CU 707 is a non-F1 terminating donor-CU for the IAB-node 701 as the IAB-MT 704 has previously been migrated to the target F1 donor-CU 707), or through the IAB topology of the non-F1 donor-CU (not shown in FIG. 7) of the IAB-node 701 if there is no backhaul path to reach the IAB-node 701 in the IAB topology controlled by the target F1 donor-CU 707 (i.e. IAB-MT 704 and IAB-DU2 706 are connected to different donor-CUs).

In this latter case, the target F1 donor-CU 707 may trigger the procedure described with reference to FIG. 9b to request traffic migration to the non-F1 donor-CU of the IAB-node 701. As an example of this latter case with reference to FIG. 5, the IAB-node 701 is the IAB-node 570 of FIG. 5 connected to IAB-node 550 via backhaul link 5050 and where the MT (MT 571 which corresponds to IAB-MT 704 in FIG. 7) of the IAB-node 570 has been migrated to the non-F1 donor CU 502 and the IAB donor CU 501 is the F1 donor CU. When the DU (DU 572 which corresponds to IAB-DU2 706 in FIG. 7) of the IAB-node 570 has been migrated to the target donor CU 503, and so has a F1 connection to the F1 donor CU 503, but the MT 571 remains connected through its RRC connection to the non-F1 donor-CU 502, (its RRC connection), the backhaul path(s) to/from the IAB-node 570 is set up in the IAB topology 5002 controlled by the IAB donor CU 502 (i.e. a backhaul path to the IAB node 570 through the IAB donor DU 506, IAB nodes 540 and 550) by performing the traffic migration procedure (e.g. as described with reference to FIG. 9b).

After the handover of UE 708 and the path switch has been performed, the user data in the downstream direction are transmitted by the core network 702 to the target F1 donor-CU 707 through the bearer 740, then they are transmitted to the logical DU IAB-DU2 706 of the IAB-node 701 through the backhaul bearer 741, and finally to the UE 708 through the data radio bearer 742. The backhaul bearer 741 may be established in the IAB topology controlled by the target F1 donor-CU 707, or in the IAB topology controlled by the non-F1 donor-CU of the IAB-node 707 (e.g. depending on whether the IAB-MT 704 and IAB-DU2 706 of IAB node 701 are connected to different donor-CUs). User data in the upstream direction (not represented in the figure) are transmitted through similar bearers in the opposite direction.

Once the handover of all UEs served by the IAB-DU1 705 of the IAB-node 701 is completed, the source F1 donor-CU 703 may deactivate the logical DU IAB-DU1 705 of the mobile IAB-node 701 through the procedure described with reference to FIG. 8c. This is represented generally by the procedure 735 in FIG. 7.

Also, the source F1 donor-CU 705 may release the traffic (user traffic, control traffic) related to the UEs that were served by the IAB-node 701 through the IAB-DU1 705. If the traffic was offloaded in an IAB topology controlled by another donor-CU, the source F1 donor-CU 705 may apply the procedure described with reference to FIG. 9b to request the traffic release to the other donor-CU. This is represented generally by the procedure 735 in FIG. 7.

FIG. 8a is a schematic and simplified diagram 800 flowchart illustrating an example message flow of a procedure to perform the activation of a logical DU according to an embodiment of the invention.

This figure shows:
a RAN node DU 801, that may be DU of an IAB-node like IAB-DU 572 of IAB node 570 of FIG. 5 (and IAB-DU1 705 of IAB node 701 of FIG. 7),
a RAN node CU 802, that may be an IAB-Donor-CU like IAB-donor-CU 501 of FIG. 5 (and source F1 donor-CU 703 of FIG. 7).

The message CONFIGURATION REQUEST 803 is sent by the RAN node CU 802 to the RAN node DU 801 either to request the activation of new cell(s) controlled by the RAN node DU 801, or to request the activation of a logical DU, or to request the deactivation of cell(s) in the RAN node DU 801. In case of a logical DU activation, the message 803 may include the TNL address (i.e. IP address) of a RAN node CU (e.g. the target F1 donor-CU 707 of FIG. 7) that will connect to the logical DU once activated. For example, CONFIGURATION REQUEST 803 may be sent by the source IAB donor CU to the IAB node (e.g. the first logical DU entity 705 having a F1 connection with the source IAB donor CU) for requesting establishment of a F1 connection between a target IAB donor CU and the IAB node.

The RAN Node DU 801 may acknowledge the request with the message CONFIGURATION RESPONSE 804 sent to the RAN Node CU 802.

According to one example, the flow in FIG. 8a corresponds to the procedure gNB-CU Configuration Update procedure described in TS 38.473 V17.0.0 section 8.2.5, and the message 803 corresponds to the message GNB-CU CONFIGURATION UPDATE described in TS 38.473 V17.2.0 section 9.2.1.10, while the message 804 corresponds to the message GNB-CU CONFIGURATION UPDATE ACKNOWLEDGE described in TS 38.473 V17.2.0 section 9.2.1.11.

The message GNB-CU CONFIGURATION UPDATE includes the information Element (IE) Cells to be Activated List to indicate the list of new cell(s) to be activated at the RAN Node DU 801. For example and with reference to FIG. 7, the GNB-CU CONFIGURATION UPDATE includes information to activate the new cell(s) indicated in the IE Cells to be Activated List, which new cell(s) may be served by the first logical DU entity 705 at the IAB node 701. The cell(s) to be activated refer to cell(s) controlled by the RAN Node DU 801 receiving the request. The associated PCI and NCGI value(s) to be used by the RAN Node DU 801 may also be provided.

The message GNB-CU CONFIGURATION UPDATE may also include the Information Element (IE) Cells to be Deactivated List to indicate the list cell(s) to be deactivated. The cell(s) to be deactivated refer to cell(s) controlled by the RAN node DU 801 receiving the request. For example and with reference to FIG. 7, the GNB-CU CONFIGURATION UPDATE may include information to deactivate the cell(s) indicated in the IE Cells to be Deactivated List which cell(s) are currently served by the first logical DU entity 705 at the IAB node 701.

According to one example, a new IE Second DU Activation may be added in the message 803 in the form of a Boolean (e.g. a one-bit IE) to request the activation of a second logical DU. One value (i.e. “0” or “1”) of the one-bit IE means no specific action related to the second logical DU is requested and another value (i.e. “1” or “0”) means activation of a second logical DU is requested. This IE may be completed by a new IE for indicating the F1 setup is for the purpose of a DU migration toward a target RAN node CU (in other words, an IE for indicating the request for establishing a F1 connection is related to a DU migration of the DU of the IAB node), and/or by a new IE indicating a number of cells to be activated in the second logical DU. In the absence of this IE indicating a number of cells, the number of cells to be activated corresponds to the number of cells currently activated in the RAN Node DU 801. Another IE may also provide the list of identifiers (e.g. PCI and/or NCGI) of the cell(s), controlled by the first logical DU 705 at the IAB node 701, for which a mapping with the identifier(s) of the cell(s) to be activated is to be provided: for example, mapping may not be necessary for all of the active cell(s) controlled by the first logical DU 705 and so only the identifiers of those cells which will be mapped to identifiers of cells to be activated and controlled by a second logical DU 706 may be included in message 803.

Besides, a new IE may be added (e.g. Target TNL address IE) to identify the target RAN Node CU with which a F1 connection shall be setup.

To complete the setup of the new logical DU at the IAB node, the procedure described with reference to FIG. 8b may be used.

FIG. 8b is a schematic and simplified diagram 810 illustrating an example message flow of a procedure to setup a logical DU, so as to establish a F1 connection with the target IAB donor CU, according to an embodiment of the invention.

This figure shows:
a RAN node DU 811, that may be a DU of an IAB-node DU like IAB-DU 572 of IAB node 570 of FIG. 5 (and IAB-DU2 706 of IAB node 701 of FIG. 7),
a RAN node CU 812, that may be an IAB-Donor-CU like IAB-donor-CU 503 of FIG. 5 (and target F1 donor-CU 707 of FIG. 7).

The message SETUP REQUEST 813 is sent by the RAN node DU 811 to the RAN node CU 812 to request the F1 setup for the logical DU. For example, SETUP REQUEST 813 may be sent by the IAB node (e.g. by the second logical DU entity 706 which has been activated at the IAB node 701) to the target IAB donor CU 707 for requesting set up of a F1 connection between a target IAB donor CU and the IAB node (e.g. with the second logical DU entity 706 of the IAB node 701)). The SETUP REQUEST message 813 may be sent after an activation request as described with reference to FIG. 8a. This SETUP REQUEST message 813 may include an indication that the F1 setup is related to the DU migration of the RAN node embedding the RAN node DU 811 (e.g. information for indicating the request for establishing a F1 connection is related to a DU migration of the DU of the IAB node), and/or the number of cells to be activated along with activation of the logical DU. This SETUP REQUEST message 813 may optionally include the identifier(s) (e.g. PCI and/or NCGI) of the active cell(s) controlled by the first logical DU 705 and/or the identifiers (e.g. PCI and/or NCGI) of the active cell(s) controlled by the first logical DU 705 for which a mapping with the identifier(s) of the cell(s) to be activated is to be provided (as discussed above). This SETUP REQUEST message 813 may include a request for a mapping between the identifier(s) (e.g. PCI and/or NCGI) of the active cell(s) controlled by the first logical DU and the identifier(s) of the cell(s) to be activated (e.g. at a second logical DU of the IAB node). This SETUP REQUEST message 813 may include the TNL address (i.e. the IP address) or the identifier (i.e. Global NG-RAN Node ID as specified in TS 38.423 V17.2.0 section 9.2.2.3) of the RAN node CU terminating the F1 connection of the RAN node DU 811 (e.g. the source IAB donor CU 703). This message may include the TNL address (i.e. the IP address) or the identifier (i.e. Global NG-RAN Node ID as specified in TS 38.423 V17.2.0 section 9.2.2.3) of the RAN node CU terminating the non-F1 (i.e. RRC) connection of the RAN node DU 811 in the case where the MT (e.g. mMT 571 of IAB node 570 or corresponding IAB-MT of 704 of IAB node 701) has been migrated to the RAN node CU (which is now the non-F1 donor CU).

The RAN node CU 812 answers with the message SETUP RESPONSE 814 sent to the RAN node DU 811. It may include a list of cell(s) to activate with the logical DU, along with the associated PCI and NCGI value(s) to be used. It may also include a mapping between the identifier(s) (PCI and/or NCGI) of cell(s) to be activated by the RAN node DU 811 and the identifier(s) of the active cell(s) controlled by the first logical DU 705.

According to one example, the flow in FIG. 8b corresponds to the procedure F1 setup described in TS 38.473 V17.2.0 section 8.2.3, and the message 813 corresponds to the message F1 SETUP REQUEST described in TS 38.473 V17.2.0 section 9.2.1.4, while the message 814 corresponds to the message F1 SETUP RESPONSE described in TS 38.473 V17.2.0 section 9.2.1.5. The message F1 SETUP RESPONSE includes the Information Element (IE) Cells to be Activated List to indicate the list of new cell(s) to be activated. The cell(s) to be activated refer to cell(s) controlled by the RAN node DU 811 receiving the response.

FIG. 8c is a schematic and simplified diagram 820 illustrating an example message flow of a procedure to remove a logical DU.

This figure shows:
a RAN node DU 821, that may be a DU of an IAB-node DU like IAB-DU 572 of IAB node 570 of FIG. 5 (and IAB-DU1 705 of IAB node 701 of FIG. 7),
a RAN node CU 822, that may be an IAB-Donor-CU like IAB-donor-CU 501 of FIG. 5 (and source F1 donor-CU 703 of FIG. 7).

The message REMOVAL REQUEST 823 is sent by the RAN node CU 822 to the RAN node DU 821 to request the removal (which is equivalent to deactivation) of the logical DU. The RAN node DU 821 answers with the message REMOVAL RESPONSE 814 sent to the RAN node CU 822.

According to one example, the flow in FIG. 8c corresponds to the procedure F1 removal described in TS 38.473 V17.2.0 section 8.2.8, and the message 823 corresponds to the message F1 REMOVAL REQUEST described in TS 38.473 V17.2.0 section 9.2.1.16, while the message 824 corresponds to the message F1 REMOVAL RESPONSE described in TS 38.473 V17.2.0 section 9.2.1.7.

FIG. 8d is a schematic and simplified diagram 830 illustrating an example message flow of a procedure used by a logical DU to inform an IAB-donor-CU about a change of configuration, according to an example.

This figure shows:
a RAN node DU 831, that may be a DU of an IAB-node DU like IAB-DU 572 of IAB-node 570 of FIG. 5 (and IAB-DU1 705 of IAB-node 701 of FIG. 7),
a RAN node CU 832, that may be an IAB-donor-CU like IAB-donor-CU 501 of FIG. 5 (and source F1 donor-CU 703 of FIG. 7).

The message CONFIGURATION UPDATE 833 is sent by the RAN node DU 831 to the RAN node CU 832 to indicate a configuration change for the RAN node (e.g. IAB-node 570, 701) embedding the RAN node DU 831. CONFIGURATION UPDATE message 833 may be sent by the RAN node DU 831 for indicating to the RAN node CU 832 the completion of a F1 setup procedure with a target RAN node CU at the DU migration of the RAN node embedding the RAN node DU 831, i.e. reporting of a new F1 connection between a second logical DU activated in the RAN node (e.g. IAB-node 701) embedding the RAN node DU 831 and a target F1 terminating donor-CU (e.g. target F1 terminating donor-CU 707). This message 833 may include the identifier of the target RAN node CU (e.g. target F1 donor-CU 707). It may also include the identifier(s) (e.g. PCI and/or NCGI) of cell(s) activated in the second logical DU of the RAN node embedding the RAN node DU 831. The message 833 may, additionally or alternatively, include a mapping between the identifier(s) of cell(s) controlled by the RAN node DU 831 and the identifier(s) of cell(s) activated with this second logical DU. For instance with reference to FIG. 7, the message 833 is sent by the first logical DU entity 705, that has been activated at the IAB-node 701, to the source IAB-donor-CU 703 to indicate the completion of the F1 setup procedure toward the target IAB-donor-CU 707, optionally along with the identifier(s) of cell(s) activated at the second logical DU 706, and optionally with a mapping between the identifier(s) of cell(s) activated at the second logical DU 706 and the identifier(s) of cell(s) controlled by the first logical DU 705. This CONFIGURATION UPDATE message 833 may include the TNL address (i.e. the IP address) and/or the identifier (i.e. Global NG-RAN Node ID as specified in TS 38.423 V17.2.0 section 9.2.2.3) of the RAN node CU (e.g. target F1 donor-CU 707) terminating the new F1 connection of the RAN node embedding the RAN node DU 831.

The message 833 may indicate success or failure of the F1 setup procedure. In the event of failure of the F1 setup procedure (e.g. the F1 connection cannot be set up), message 833 may also indicate the cause of the failure to set up the F1 connection.

The RAN node CU 832 may answer or respond with the message CONFIGURATION ACKNOWLEDGE 834 sent to the RAN node DU 831.

According to one example, the flow in FIG. 8d corresponds to the procedure gNB-DU configuration update described in TS 38.473 V17.2.0 section 8.2.4, amended to include the information elements described above. The message 833 corresponds to the message GNB-DU CONFIGURATION UPDATE described in TS 38.473 V17.2.0 section 9.2.1.7, while the message 834 corresponds to the message GNB-DU CONFIGURATION UPDATE ACKNOWLEDGE described in TS 38.473 V17.2.0 section 9.2.1.8.

The message 833 may be sent following the F1 setup procedure, described with reference to FIG. 8c, and triggered either by the RAN node CU 832 (with the procedure described with reference to FIG. 8a), or by the RAN node embedding the RAN node DU 831 with a selection of the target RAN node CU based on a pre-configuration. Pre-configuration may occur, for instance, at network integration of the RAN node embedding the RAN node DU 831. For example, the F1 setup procedure may be triggered by the RAN node CU 832 (e.g. source IAB donor CU 703/501) or by the RAN node (IAB node 701/570) embedding the RAN node DU 831 (e.g. IAB-DU1 572) determining the RAN node DU 831 is to be migrated to a target RAN node CU (e.g. target IAB donor CU 707/503).

FIG. 9a is a schematic and simplified diagram 900 illustrating an example message flow of a procedure used by a RAN Node CU to report the activation of cell(s) to another RAN Node CU according to an embodiment of the invention.

This figure shows two RAN nodes, RAN node CUa 901 and RAN node CUb 902, that may be two IAB-Donor-CUs, like two of IAB-donor-CUs 501, 502, and 503 of FIG. 5. With respect to the example shown in FIG. 7, RAN node CUa 901 is the target F1 donor-CU 707 and RAN node CUb 902 is the source F1 donor-CU 703.

The message CONFIGURATION UPDATE 903 is sent by the RAN node CUa 901 to the RAN node CUb 902 to inform the RAN node CUb 902 about the activation of new cell(s) in a logical DU of a RAN node DU like the IAB-DU2 706 of the IAB-node 701. For example, the source F1 donor-CU 703 receives the CONFIGURATION UPDATE message 903 from the target F1 donor-CU 707 and the CONFIGURATION UPDATE message 903 includes identification information (e.g. PCI, NCGI) identifying one or more new cells that have been activated at a second logical DU entity (IAB-DU2 706) of the DU of the IAB node 701. In addition, the message 903 may include a mapping between the identifier(s) (PCI and/or NCGI) of cell(s) activated at a second logical DU (IAB-DU2 706) and the identifier(s) of the active cell(s) controlled by the first logical DU (IAB-DU1 705).

The RAN node CUb 902 answers with the message CONFIGURATION ACKNOWLEDGE 904 sent to the RAN node CUa 901.

According to one example, the FIG. 9a corresponds to the procedure NG-RAN node configuration update described in TS 38.423 V17.2.0 section 8.4.2, and the message 903 corresponds to the message NG-RAN NODE CONFIGURATION UPDATE described in TS 38.423 V17.2.0 section 9.1.3.4, while the message 904 corresponds to the message NG-RAN NODE CONFIGURATION UPDATE ACKNOWLEDGE described in TS 38.423 V17.2.0 section 9.1.3.5.

FIG. 9b is a schematic and simplified diagram 910 illustrating an example message flow of a procedure used by a RAN node CU to manage the transport migration (e.g. migration or release of F1 traffic such as user/control traffic) in coordination with another RAN Node CU according to an embodiment of the invention.

This figure shows two RAN nodes, RAN node CUa 911 and RAN node CUb 912, that may be two IAB-Donor-CUs, like two of IAB-donor-CUs 501, 502, and 503 of FIG. 5.

The message TRANSPORT MIGRATION REQUEST 913 is sent by the RAN node CUa 911 to the RAN node CUb 912 to request the traffic migration or release in the IAB topology controlled by the RAN node CUb 912. For example, with reference to FIG. 7, in the case where the MT 704 of the IAB node 701 had been migrated to a non-F1 donor CU (not shown in FIG. 7), the source F1 donor-CU 703 may send a TRANSPORT MIGRATION REQUEST 913 to the non-F1 donor CU to request release of the traffic (e.g. F1 traffic) migrated to the non-F1 donor CU's topology (i. e as the F1 traffic is now to be routed from the target F1 donor-CU 707 through the IAB topology managed by the non-F1 donor CU). Alternatively, in the case where the MT 704 of the IAB node 701 had been migrated to a non-F1 donor CU (not shown in FIG. 7), the target F1 donor-CU 707 may send a TRANSPORT MIGRATION REQUEST 913 to the non-F1 donor CU to request traffic (e.g. F1 traffic) migration to the non-F1 donor CU's topology (i. e as the F1 traffic is now to be routed from the target F1 donor-CU 707 through the IAB topology managed by the non-F1 donor CU).

The RAN node CUb 912 answers with the message TRANSPORT MIGRATION RESPONSE 914 sent to the RAN node CUa 901 to accept or reject the request.

Depending on the situation, the FIG. 9b may correspond to the IAB transport migration management procedure specified in TS 38.423 V17.2.0 section 8.5.2. The message 913 corresponds to the IAB TRANSPORT MIGRATION MANAGEMENT REQUEST message specified in TS 38.423 V17.2.0 section 9.1.4.2, and the message 914 corresponds to the IAB TRANSPORT MIGRATION MANAGEMENT RESPONSE message specified in TS 38.423 V17.2.0 section 9.1.4.3. The FIG. 9b may also correspond to the IAB transport migration modification procedure specified in TS 38.423 V17.2.0 section 8.5.3. The message 913 corresponds to the IAB TRANSPORT MIGRATION MODIFICATION REQUEST message specified in TS 38.423 V17.2.0 section 9.1.4.4, and the message 914 corresponds to the IAB TRANSPORT MIGRATION MODIFICATION RESPONSE message specified in TS 38.423 V17.2.0 section 9.1.4.5.

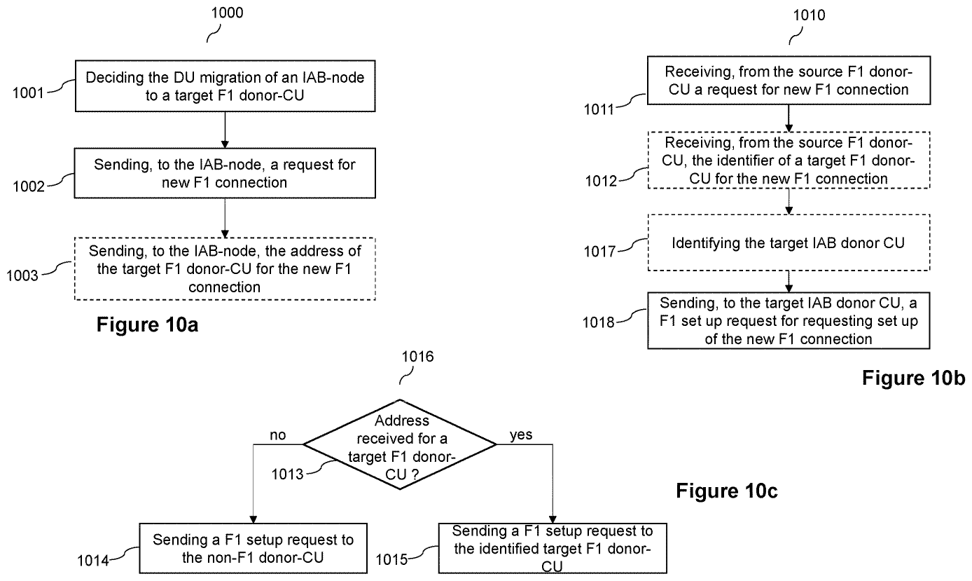

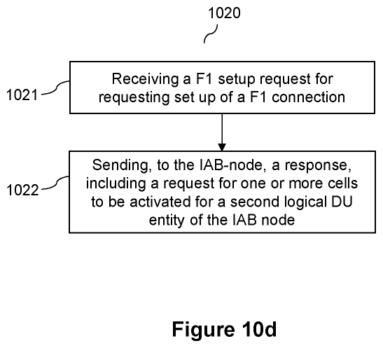

FIG. 10a is a flowchart showing an example method 1000 in accordance with one or more embodiments of the invention, performed at the source IAB donor CU for use in a migration process (or for use in part of a migration process) in which a Distributed Unit, DU, of an IAB node is migrated from one IAB topology managed by the source IAB donor CU to another IAB topology managed by a target IAB donor CU. Method 1000 is for managing, at the source F1 terminating donor-CU of an IAB-node, the DU migration of the IAB-node toward a target IAB topology. For example, with reference to the IAB communication system shown in and described with respect to FIG. 5, the source IAB donor CU performing the method 1000 may be the IAB donor CU 501 (e. g a F1 terminating donor CU of the IAB node 570 with which the IAB node 570 retains a F1 connection). The IAB node may be mobile IAB-node 570 belonging to IAB topology 5001 controlled by the IAB donor CU 501. The migration process may involve the migration of the DU 572 of the IAB node 570 from IAB topology 5001 to IAB topology 5003 managed by IAB donor CU 503 which is the target IAB donor CU. With reference to FIG. 7, the IAB node may be IAB-node 701 and the migration process may involve the migration of the DU of the IAB-node 701 from the source F1 donor-CU 703 to the target F1 donor-CU 707. The method 1000 as shown in and described with respect to FIG. 10a may be performed by software elements and/or hardware elements. The source IAB donor CU may be implemented in a communication device 400 as shown in and described with reference to FIG. 4 with the method as shown in and described with respect to FIG. 10a being performed by one or more processing units, such as the central processing unit 411.

At step 1001, the source F1 terminating donor-CU, like the donor-CU 501 of FIG. 5 (703 of FIG. 7), determines that the DU of the IAB node, like the IAB-node 570 of FIG. 5 (701 of FIG. 7) is to be migrated from the source F1 donor-CU 501, 703 to a target F1 donor-CU, like the donor-CU 503 of FIG. 5 (707 of FIG. 7). For example, the source F1 donor-CU 503, 707 decides the DU migration of an IAB-node, like the IAB-node 570, toward a target F1 donor-CU, like the donor-CU 503. For example, the source F1 donor-CU 501, 703 may determine that the DU of the IAB node 570, 701 is to be migrated in response to determining the migration of the MT of the IAB node 570, 701 toward a new parent IAB node (which may be a new IAB node or a new IAB donor DU) has been completed. Examples of other triggers for determining the DU is to be migrated are described above. Details of how the source F1 donor-CU 501, 703 determines the target F1 donor-CU 503, 707 is also described above.

At step 1002, the source F1 terminating donor-CU 501, 703 sends to the IAB-node a request for establishing a F1 connection (i.e. a new F1 connection) between the target IAB donor CU 503, 707 and the IAB-node 570, 701 (e.g. a new F1 association with the target IAB donor CU). For example, the source F1 terminating donor-CU 501, 703 sends to the IAB-node 570, 701 to be migrated, a request for a new F1 connection. The request may be the CONFIGURATION REQUEST 803 described with reference to FIG. 8a. The source F1 donor-CU 501, 703 may send, to the IAB-node, information indicating the F1 connection is for the purpose of DU migration toward a target IAB-donor-CU (e.g. information indicating the request for establishing a F1 connection is related to a DU migration of the DU of the IAB node), and/or information indicating a number of cells to be activated at a second logical DU entity of the DU of the IAB-node. The source F1 donor-CU 501, 703 may optionally send identifier(s) (e.g. PCI and/or NCGI) of the active cell(s) controlled by the first logical DU 705 for which a mapping with the identifier(s) of cell(s) to be activated (e.g. at a second to be activated logical DU) is to be provided.

Optionally, at step 1003, the source F1 terminating donor-CU 501, 703 sends, to the IAB node 570, 701, identification information for identifying the target IAB donor CU 503, 707. The identification information may be the TNL address (i.e. IP address) of the target IAB donor CU 503, 707. For example, the source F1 terminating donor-CU 501, 703 sends to the IAB-node to migrate, the address of the target F1 donor-CU for the new F1 connection. In the case where the IAB-MT 704 has been migrated to a non-F1 donor-CU (which may be referred to as a RRC donor-CU), the identification information sent by the source F1 terminating donor-CU 501, 703 may include the address of the non-F1 donor-CU (albeit the IAB node 701 may already have this information) to identify the non-F1 donor-CU as the target F1 donor-CU.

The source F1 terminating donor-CU 703 may receive, from the target F1 donor-CU 707 or from the IAB-node 570, 701, identification information (e.g. identifiers) identifying one or more new cells that have been activated at a second logical DU entity of the DU of the IAB node, optionally along with mapping information indicating a mapping between identification information (e.g. the identifier(s)) of one or more new or target cell(s) activated at the second logical DU and identification information (e.g. the identifier(s)) of source cell(s) or active cells controlled by the first logical DU. As discussed above, the DU of the IAB node has a first logical DU entity with a F1 connection to the source F1 terminating donor-CU 703 and a second logical DU entity is activated in order to perform DU migration (e.g. to establish a new F1 connection between the target F1 donor-CU 707 and the IAB node 701). For example, the identification information and optional mapping information may be received in a CONFIGURATION UPDATE message 903 described above.

In an example, the source F1 terminating donor-CU 703 may send, to the target F1 donor-CU 707, a handover request for requesting handover, from the source F1 terminating donor-CU 703 to the target F1 donor-CU 707, of one or more User Equipment, UE, (such as UE 708) served by the IAB node 701 and for identifying one or more target cells (e.g. candidate target cells) for each UE. The selection of target cell(s) for a UE may be based on the measurement report provided by the UE (e.g. indication the signal strength detected by the UE for one or several cells), or based on the mapping between the identifier(s) of target cell(s) activated at the second logical DU and the identifier(s) of source cell(s) controlled by the first logical DU. For example, the source F1 terminating donor-CU 703 may select one or more of the new cells that have been activated at the second logical DU entity 706 as one or more candidate target cells for each UE of the one or more UEs served by the IAB node based on the mapping information received from the target F1 donor-CU 707 or the IAB node 701. The use of the mapping avoids waiting for the measurement report from the UE to trigger the handover procedure. In response to receiving a handover acknowledgement from the target F1 donor-CU 707 indicating handover of the one or more UE has been accepted and identifying a target cell for each UE, the source F1 terminating donor-CU 703 sends to the IAB node 701, configuration information for configuring each of the one or more UE for the respective target cell. The handover acknowledgement from the target F1 donor-CU 707 may also include the configuration information for configuring each of the one or more UE for the respective target cell. The Handover procedure 730 discussed above may be performed for these steps.

After handover of the one or more UE 708 to the target F1 donor-CU 707 is completed, the source F1 terminating donor-CU 703 may send, to the IAB node 701, a request for deactivating a first logical DU entity (e.g. IAB-DU1 705) of the DU of the IAB node 701. The request may be a deactivation request sent in the CONFIGURATION REQUEST message 803 or a removal request sent in the message 823.

After handover of the one or more UE 708 to the target F1 donor-CU 707 is completed and when a Mobile Termination, MT, (e.g. IAB-MT 704) of the IAB node 701 has been migrated to a non-F1 donor CU, the source F1 terminating donor-CU 703 may send, to the non-F1 donor-CU, a traffic migration request (e.g. message 913) for requesting traffic release for the traffic associated with the IAB node that was routed via one or more paths in an IAB topology managed by the non-F1 donor CU.

FIG. 10b is a flowchart showing an example method 1010, in accordance with one or more embodiments of the invention, performed at an IAB node (e.g. a mobile IAB node or mIAB node) for use in a migration process (or for use in part of a migration process) in which a Distributed Unit, DU, of the IAB node is migrated from one IAB topology managed by a source IAB donor CU to another IAB topology managed by a target IAB donor CU. Method 1010 is for managing, at an IAB-node, the DU migration toward a target F1 terminating donor-CU. For example, with reference to the IAB communication system shown in and described with respect to FIG. 5, the IAB node performing the method 1010 may be the mobile IAB-node 570 belonging to IAB topology 5001 controlled by the IAB donor CU 501 (e.g. a F1 terminating donor CU of the mobile IAB node 570 with which the mobile IAB node 570 retains a F1 connection) which is the source IAB donor CU. The migration process may involve the migration of the DU 572 of the IAB node 570 from IAB topology 5001 to IAB topology 5003 managed by IAB donor CU 503 which is the target IAB donor CU. With reference to FIG. 7, the IAB node may be mobile IAB-node 701 and the migration process may involve the migration of the DU of the IAB-node 701 from the source F1 donor-CU 703 to the target F1 donor-CU 707. The method 1010 as shown in and described with respect to FIG. 10b may be performed by software elements and/or hardware elements. The IAB node may be implemented in a communication device 400 as shown in and described with reference to FIG. 4 with the method as shown in and described with respect to FIG. 10b being performed by one or more processing units, such as the central processing unit 411.

At step 1011, an IAB-node, like the IAB-node 570 of FIG. 5 (701 of FIG. 7), receives from a source F1 terminating donor-CU, like the donor-CU 501 of FIG. 5 (703 of FIG. 7), a request for a new F1 connection (for example, a F1 connection between the IAB-node 570, 701 and a target F1 donor CU, like the donor-CU 503 of FIG. 5 (707 of FIG. 7)). The request may be the CONFIGURATION REQUEST 803 described with reference to FIG. 8a.

In response to receiving a request for a new F1 connection, the IAB node 570, 701 then sends, to the target F1 donor CU 503, 707, a F1 setup request requesting set up of the F1 connection (step 1018). For example, the setup request may be the SETUP REQUEST 813 described above. The F1 setup request message sent by the IAB node may include identification information for identifying the source F1 terminating donor-CU or identification information for identifying a non-F1 donor CU (which may be referred to as a RRC donor-CU) when a Mobile Termination, MT, of the IAB node has been migrated to the non-F1 donor CU.

The IAB node 570, 701 may identify or determine the identity of the target F1 donor CU 503, 707 in response to receiving the request for establishing a F1 connection (step 1017) and the F1 setup request is then sent to the identified target F1 donor CU. The IAB node 570, 701 may identify the target F1 donor CU based on identification information for the target F1 donor CU 503, 707, such as the address (e.g. the TNL address/IP address) of the target F1 donor CU 503, 707, received from the source F1 donor-CU 501, 703 (e.g. in the message with the CONFIGURATION REQUEST 803 or sent separately), as shown by optional step 1012. In the case where the IAB-MT 704 has been migrated to a non-F1 donor-CU, the identification information received at the IAB node may include the address of the non-F1 donor-CU in which case, the IAB node will identify the non-F1 donor-CU as the target F1 donor CU. Alternatively, if an address of the target F1 donor CU is not received from the source F1 donor-CU 501, 703, and in the case where the IAB-MT 704 has been migrated to a non-F1 donor-CU, the IAB node 570, 701 identifies or determines the identity of the target donor CU 503, 707 (e.g. following receipt of the request to establish a F1 connection) by considering/identifying the non-F1 Donor-CU as the target F1 donor-CU. For example, in this case, the IAB-node 701 has already been informed of the address (e.g. the TNL address/IP address) of target donor-CU when the IAB-MT 704 was migrated to the non-F1 Donor-CU and so can identify the address of the non-F1 Donor CU as the address of the target donor-CU.

Optionally, at step 1012, the IAB-node 570, 701 receives from the source F1 terminating donor-CU 501, 703 identification information for identifying the target F1 donor CU 503, 707. The identification information may include the address (e.g. the TNL address/IP address) of a target F1 terminating donor-CU for the new F1 connection.

As another method (e.g. instead of steps 1011, 1012), which another method is not shown in the figures, the IAB-node 570, 701 may also trigger itself to send the request for new F1 connection and identify the target F1 donor-CU based on a pre-configuration. Thus, the IAB-node 570, 701 itself may determine a new F1 connection is to be set up and may identify the IAB donor CU with which the connection is to be set up based on pre-configuration information pre-configured at the IAB node and may then send to the identified target IAB donor CU a F1 setup request for requesting set up of the F1 connection. As a first example, the triggering condition may be the detection by the IAB-node 570, 701 of a cell or several cells in the vicinity of the IAB node with an identifier (NCGI) associated to a donor-CU belonging to a pre-configured list of target donor-CUs. In other words, the IAB-node 570, 701 may determine that a new F1 connection is to be set up (e.g. as the DU (e.g. 572) of the IAB node 570/701 is to be migrated) and may identify the IAB donor CU with which the connection is to be set up based on pre-configuration information in response to or after detecting one or more cells in the vicinity of the IAB-node 570, 701, which one or more cells are associated with an IAB donor CU which is included in a list of candidate target IAB donor CUs pre-configured at the IAB node. As a second example, the triggering condition is at network integration of the IAB-node, when a first F1 connection with an IAB-donor-CU identified by pre-configuration has to be set up after the establishment of a RRC connection of the IAB-MT with an IAB-donor-CU (which depends on the physical location of the IAB-node). In other words, the IAB-node 570, 701 may determine that a new F1 connection is to be set up at network integration of the IAB-node 570/701 (e.g. when the IAB-node 570/701 connects to the network) and the IAB-node 570/701 identifies the IAB-donor CU with which the F1 connection is to be set up based on a list of candidate IAB donor CUs pre-configured at the IAB node and the location of the IAB-node.

FIG. 10c shows example steps, in accordance with one or more embodiments of the invention, performed at an IAB node (e.g. a mobile IAB node or mIAB node) to identify the target IAB donor CU. In an example, step 1017 of FIG. 10b may be performed by carrying out the steps 1013-1015, which together are referred to as step 1016, of FIG. 10c. In the alternative method where the IAB-node 570, 701 itself may determine a new F1 connection is to be set up (without receiving a request for a new F1 connection), steps 1013-1015 can be performed at the IAB node in order to identify the IAB donor CU with which the connection is to be set up based on pre-configuration information pre-configured at the IAB node.

At step 1013, the IAB-node 701 determines whether identification information for identifying the target IAB donor CU for the F1 connection has been received from the source IAB donor CU (or by pre-configuration), by checking if an address of the target F1 terminating donor-CU for the new F1 connection has been received. If yes, at step 1015, the IAB-node 701 identifies the target F1 terminating donor-CU from the received identification information and the IAB-node sends a F1 setup request to the identified target F1 terminating donor-CU. If no, at step 1014, the IAB-node 701 identifies the non-F1 terminating donor-CU (which may be referred to as a RRC donor-CU) as the target F1 terminating donor-CU from the received identification information and the IAB-node sends a F1 setup request to its non-F1 terminating donor-CU (for instance donor-CU 502).

The request for a new F1 connection received at the IAB node 701 (e.g. in CONFIGURATION REQUEST 803) may include a request for one or more cells to be activated for a second logical DU entity (e.g. IAB-DU2 706), and may optionally include identifier(s) (e.g. PCI and/or NCGI) of the active cell(s) controlled by the first logical DU, and/or with the identifiers (e.g. PCI and/or NCGI) of the active cell(s) for which a mapping with the identifier(s) of the cell(s) to be activated is to be provided. As discussed above, the DU of the IAB node has a first logical DU entity with a F1 connection to the source F1 terminating donor-CU 703 and a second logical DU entity is activated in order to perform DU migration (e.g. to establish a new F1 connection between the target F1 donor-CU 707 and the IAB node 701). In an example, the IAB node 701 activates a second logical DU entity (e.g. IAB-DU2 706) in response to receiving the request for establishing a F1 connection (e.g. in CONFIGURATION REQUEST 803). In both these cases, the F1 setup request (e.g. message 813) is sent by the second logical DU entity. The F1 setup request message sent to the target F1 terminating donor-CU 707 may include information indicating the number of cells to be activated with the activation of a second logical DU at the IAB node and/or information indicating the request for establishing a F1 connection is related to a DU migration of the DU of the IAB node. Optionally, the F1 setup request message includes a request for a mapping between the identifier(s) (e.g. PCI and/or NCGI) of the active cell(s) controlled by the first logical DU and the identifier(s) of the cell(s) to be activated. In an example, after sending the F1 setup request, the IAB node 701 receives, from the target F1 terminating donor-CU 707, a response (such as the SETUP response 814) which includes a request for one or more cells to be activated for the second logical DU entity. The response may include identification information, such as an identifier of each of the cell(s) to be activated.

The IAB node 701 may receive from the source F1 donor-CU 703 a request (e.g. a Removal Request 823 or a deactivation request in the CONFIGURATION REQUEST 803) for deactivating a first logical DU entity (e.g. IAB-DU1 705) of the DU of the IAB node 701 and in response to the request, the IAB node 701 deactivates the first logical DU entity (e.g. IAB-DU1 705).

FIG. 10d is a flowchart showing an example method 1020 in accordance with one or more embodiments of the invention, performed at the target IAB donor CU for use in a migration process (or for use in part of a migration process) in which a Distributed Unit, DU, of an IAB node is migrated from one IAB topology managed by a source IAB donor CU to another IAB topology managed by the target IAB donor CU. Method 1020 is for managing, at the target F1 terminating donor-CU, the DU migration of the IAB-node toward a target IAB topology managed by the target F1 terminating donor-CU. For example, with reference to the IAB communication system shown in and described with respect to FIG. 5, the target IAB donor CU performing the method 1020 may be the IAB donor CU 503 which controls IAB topology 5003. The IAB node may be mobile IAB-node 570 belonging to IAB topology 5001 controlled by the IAB donor CU 501. The migration process may involve the migration of the DU 572 of the IAB node 570 from IAB topology 5001 to IAB topology 5003. With reference to FIG. 7, the IAB node may be IAB-node 701 and the migration process may involve the migration of the DU of the IAB-node 701 from the source F1 donor-CU 703 to the target F1 donor-CU 707. The method 1020 as shown in and described with respect to FIG. 10d may be performed by software elements and/or hardware elements. The target IAB donor CU may be implemented in a communication device 400 as shown in and described with reference to FIG. 4 with the method as shown in and described with respect to FIG. 10d being performed by one or more processing units, such as the central processing unit 411.

At step 1021, the target IAB donor CU, like IAB donor CU 503 of FIG. 5 (707 of FIG. 7), receives from an IAB node, like IAB node 570 of FIG. 5 (701 of FIG. 7), a F1 setup request for requesting set up of a F1 connection between the target IAB donor CU and the IAB node. For example, the setup request may be the SETUP REQUEST 813 described above. The F1 setup request message sent by the IAB node may include identification information for identifying the source F1 terminating donor-CU or identification information for identifying a non-F1 donor CU (which may be referred to as a RRC donor-CU) when a Mobile Termination, MT, of the IAB node has been migrated to the non-F1 donor CU. The F1 setup request message may include information indicating the number of cells to be activated with the activation of a second logical DU at the IAB node and/or information indicating the request for establishing a F1 connection is related to a DU migration of the DU of the IAB node. Optionally, the F1 setup request message may include identifier(s) (e.g. PCI and/or NCGI) of the active cell(s) controlled by the first logical DU, and/or with the identifiers (e.g. PCI and/or NCGI) of the active cell(s) for which a mapping with the identifier(s) of the cell(s) to be activated is to be provided. The F1 setup request message may additionally or alternatively include a request for a mapping between the identifier(s) (e.g. PCI and/or NCGI) of the active cell(s) controlled by the first logical DU and the identifier(s) of the cell(s) to be activated (e.g. at a second logical DU of the IAB node).

At step 1022, the target IAB donor CU 503, 707, in response to receiving the F1 setup request, sends a response (such as the SETUP response 814) to the IAB node 570, 701, which response includes a request for one or more cells to be activated for a second logical DU entity of the IAB node 570, 701. As discussed above, the DU of the IAB node has a first logical DU entity with a F1 connection to the source F1 terminating donor-CU 703 and a second logical DU entity is activated in order to perform DU migration (e.g. to establish a new F1 connection between the target F1 donor-CU 707 and the IAB node 701). The response may include identification information identifying each of the one or more cells to be activated (e.g. an identifier for each of the cell(s) to be activated). Optionally, the response may also include a mapping between the identifier(s) (e.g. PCI and/or NCGI) of the active cell(s) controlled by the first logical DU and the identifier(s) of the cell(s) to be activated. The target IAB donor CU 503, 707 or the IAB-node 570, 701 may send, to the source IAB donor CU 501, 703, identification information identifying each of one or more new cells that have been activated at the second logical DU entity of the DU of the IAB node 570, 701. The target IAB donor CU 503, 707 or the IAB-node 570, 701 may also send, to the source IAB donor CU 501, 703, the mapping information.

In an example, the target F1 donor-CU 707 may receive, from the source F1 terminating donor-CU 703, a handover request for requesting handover, from the source F1 terminating donor-CU 703 to the target F1 donor-CU 707, of one or more User Equipment, UE, (such as UE 708) served by the IAB node 701 and for identifying one or more target cells (e.g. candidate target cells) for each UE. The selection of target cell(s) for a UE may be based on the measurement report provided by the UE (e.g. indication of the signal strength detected by the UE for one or several cells), or based on the mapping between the identifier(s) of target cell(s) activated at the second logical DU and the identifier(s) of source cell(s) controlled by the first logical DU. For example, the source F1 terminating donor-CU 703 may select one or more of the new cells that have been activated at the second logical DU entity 706 as one or more candidate target cells for each UE of the one or more UEs served by the IAB node 701 based on the mapping information received from the target F1 donor-CU 707 or the IAB node 701. The use of the mapping avoids waiting for the measurement report from the UE to trigger the handover procedure. When the target F1 donor-CU 707 determines the handover of the one or more UE can be accepted, the target F1 donor-CU 707 sends, to the source F1 terminating donor-CU 703, a handover acknowledgement indicating handover of the one or more UE has been accepted and identifying a target cell for each UE. The handover acknowledgement may also include configuration information for configuring each of the one or more UE for the respective target cell. The Handover procedure 730 discussed above may be performed for these steps. After handover of the one or more UE 708 to the target F1 donor-CU 707 is completed and when a Mobile Termination, MT, (e.g. IAB-MT 704) of the IAB node 701 has been migrated to a non-F1 donor CU, the target F1 donor-CU 707 may send, to the non-F1 donor-CU, a traffic migration request (e.g. message 913) for requesting traffic migration for the traffic associated with the IAB node that was routed via one or more paths in an IAB topology managed by the non-F1 donor CU.

Thus, by sending a request to the IAB node for establishing a F1 connection between the IAB node and the target IAB donor CU, the source F1 donor CU (e.g. source IAB donor CU) facilitates DU migration of an IAB-node with or without (multiple) MT migration(s).

Furthermore, in response to receiving the request to establish a F1 connection, the IAB node can identify (e.g. via identification information sent by the source donor CU or when no identification information is sent by the source donor CU, by determining a non-F1 donor CU is the target donor CU) the target donor CU to enable the handover of UEs served by the IAB-node to the target donor CU.

The determination that the DU of an IAB node is to be migrated may be triggered by an event. What event or events trigger the determination that the DU of an IAB node is to be migrated may be left to implementation. For example, the decision for DU migration may be based on the detection of a MT migration from a first IAB topology toward a second IAB topology, and on a known (predefined) trajectory of the IAB-node that indicates to the source F1 donor-CU that the MT will be migrated later to a third IAB topology. In this case, to avoid signaling messages for DU migration/UEs handover toward the second IAB topology, the DU is directly migrated toward the third IAB topology. Another triggering event may be when the processing load level is detected above a predefined threshold in the source F1 donor-CU. Then DU migration is triggered and the choice of target F1 donor-CU is based on the processing load of other donor-CUs connected to the source F1 donor-CU.

In other words and as a summary, the triggering events and the decision process for a F1 terminating donor CU to execute the mobile IAB-DU (mIAB-DU) migration for a mobile IAB-node may be left to implementation. Besides, for flexible IAB network management, it should be allowed to migrate the mIAB-DU towards a target F1 terminating donor-CU different from the non-F1 terminating donor-CU (which may be referred to as a RRC terminating donor-CU) serving the co-located mobile IAB-MT (mIAB-MT).

Thus, the IAB-DU of a mobile IAB-node may be migrated towards a target F1 terminating donor-CU different from the non-F1 terminating donor-CU serving the co-located IAB-MT.

Then, when the F1 donor CU serving the mIAB-DU decides whether to execute mIAB-DU migration, it may request the mobile IAB-node to activate a second logical DU to be served by a target F1 donor-CU identified in the request.

For instance, the F1 donor-CU may trigger the gNB-CU Configuration Update procedure to request the mobile IAB-node to setup a new F1 connection with an identified target F1 donor-CU. Then, the activated logical DU triggers a F1 setup procedure with the target F1 donor-CU. In case the request from the F1 donor-CU does not identify a target F1 donor-CU, then the activated logical DU triggers a F1 setup procedure with the non-F1 terminating donor-CU of the mobile IAB-node.

Thus, when requested by its serving F1 donor CU to setup a new F1 connection, a mobile IAB-node may execute a F1 setup procedure with the target F1 donor-CU indicated in the request. In the absence of such indication, the mobile IAB-node executes the F1 setup procedure with the non-F1 terminating donor-CU.

To trigger the handover of UEs served by the mobile IAB-node during the mIAB-DU migration, the target F1 donor-CU may inform the source F1 donor-CU about the activation of new cell(s) in the second logical DU of the mobile IAB-node. For this purpose, the target F1 donor-CU may execute the NG-RAN node configuration update procedure with the source F1 donor-CU. Once informed, the source F1 donor-CU can send a handover command to the UEs served by the migrating mobile IAB-node.

Thus, the NG-RAN node configuration update procedure may be used by the target F1 terminating donor-CU of a mobile IAB-node to inform the source F1 terminating donor-CU about the ID(s) of the cell(s) served by the second logical DU of the mobile IAB-node.

About the procedures for triggering, executing, and reporting F1 setup at DU migration, it can be observed that to trigger the DU migration of a mobile IAB-node decided by the source F1 donor-CU, the following information may be passed to the mobile IAB-node:
The indication that a DU migration is requested (mandatory), meaning that a F1 setup procedure shall be initiated with a target logical DU.
The identifier of the target F1 donor-CU (optional). This information element is relevant when the DU is migrated toward a target F1 donor-CU different from the non-F1 donor-CU serving the co-located mobile IAB-MT. In the absence of such indication, the mobile IAB-node should execute the F1 setup procedure toward the non-F1 terminating donor-CU.

Given the low number of bits for this signalling, it may not be necessary to create a new F1AP procedure. Besides, this is related to the F1 interface management, so the gNB-CU Configuration Update procedure seems appropriate for this signaling.

Then it is proposed that the gNB-CU Configuration Update procedure can be used by a source CU to trigger the F1-Setup procedure for the purpose of DU migration toward a target CU.

In the F1 setup request message, the mobile IAB-node should pass the following information to the target F1 donor-CU:
The indication that the F1 setup request is related to a DU migration. Thanks to this information element, the target F1 donor-CU is aware of the context and can correctly handle the request.
The PCI(s) of active cell(s) at the source logical DU. This information element helps the target F1 donor-CU to select appropriate PCI(s) for the cell(s) to be activated at the target logical DU.

Then, it is proposed that in the scope of DU migration of a mobile IAB-node, the F1 setup request sent to the target F1 donor-CU should include the explicit indication that the F1 setup is related to the DU migration of a mobile IAB-node, and it should include the list of PCIs at the source logical DU of this mobile IAB-node.

To report the outcome of the F1 setup procedure for the purpose of DU migration of a mobile IAB-node, the mobile IAB-node may pass the following information to the source F1 donor-CU:
The indication of success or failure of the F1 setup and, in case of failure, the cause of failure may be indicated.
The ID(s) of the cell(s) activated by the target F1 donor-CU at the target logical DU.
The mapping between the IDs of cells activated at the target logical DU and the IDs of cells active at the source logical DU as an optional information element. Thanks to this mapping, it should be possible to limit the range of measurement to be performed at the UEs, it may even avoid measurement reports from the UEs to launch the handover. As the gNB-CU Configuration Update procedure seems appropriate to trigger the F1 setup, the gNB-DU Configuration Update procedure seems also the good candidate of existing F1AP procedures to report the outcome of the F1 setup.

Then, it is proposed that the gNB-DU Configuration Update procedure can be used by a mobile IAB-node to report to the source CU of DU migration the outcome of F1-Setup procedure toward the target CU, and it is proposed that the mapping between the IDs of cells activated at the target logical DU and the IDs of cells active at the source logical DU is included as an optional information element in the report of F1 setup outcome.

About providing identification information to a F1 donor-CU, it can be observed that at DU migration of a mobile IAB-node toward a target F1 donor-CU different from the non-F1 donor-CU of the collocated mobile IAB-MT, the identifier of the non-F1 donor-CU and the XnAP UE ID of the mobile IAB-MT at this CU shall be provided to the target F1 donor-CU. Thanks to these information elements, the target F1 donor-CU will be able to execute the Transport Migration Management procedure toward the non-F1 donor-CU.

Besides, during network integration where mIAB MT and the co-located mIAB-DU integrates to different donor CUs, mIAB-MT's UE XnAP ID assigned by the MT's CU and the gNB-ID of the MT's CU shall be known to the mIAB-DU's CU.

Considering the network integration case, there are two options:
Option 1: the mobile IAB-node provides the identification information based on information received from the non-F1 donor-CU (i.e. the mIAB-MT's CU),
Option 2: the non-F1 donor-CU provides the identification information once the non-F1 donor-CU knows the identifier of the F1 donor-CU (i.e. the mIAB-DU's CU) from the mobile IAB-node.

The drawback of option 2 is that it requires the F1 donor-CU to generate a UE XnAP ID for the mIAB-MT, to provide it to the mobile IAB-node that will pass it to the non-F1 donor CU along with the identifier of the F1 donor-CU. This UE XnAP ID generated by the F1 donor-CU will be used by the non-F1 donor-CU in the XnAP message sent to the F1 donor-CU with the option 2. Therefore, option 1 seems to have less specifications impact than option 2.

In case option 1 is adopted and for the sake of consistency, the mobile IAB-node should also provide the identification information related to the non-F1 donor-CU to the target F1 donor-CU at DU migration. This could be done through the same F1AP signaling as for the network integration case.

Going further, the mobile IAB-node should also provide to its F1 donor-CU the identification information related to the target non-F1 donor-CU at a (consecutive) MT migration, still using the same F1AP signaling.

To cover all the scenarios considered above, the F1AP procedure gNB-DU Configuration Update is appropriate as it can be triggered at any time.

Then, it is proposed that the gNB-DU Configuration Update procedure can be used by a mobile IAB-node to inform the F1 donor-CU about the identifier of the non-F1 donor-CU and the XnAP UE ID of the mobile IAB-MT at this CU. This procedure may be applied at network integration, DU migration, and MT migration of the mobile IAB-node.

It can be noted that the mIAB-MT's source donor CU can send the information on the mIAB-MT's target donor CU to the mIAB-DU's donor CU after the completion of IAB-MT HO.

Actually, the proposal is compatible with this statement as the source non-F1 donor-CU (i.e. the mIAB-MT's source donor CU) would pass the information to the F1 donor-CU (i.e. the mIAB-DU's donor CU), not directly, but through the mobile IAB-node.

Besides the proposal does not preclude that the identifier of the non-F1 donor-CU and the XnAP UE ID of the mobile IAB-MT at this CU can be included in the F1 setup request sent to the target F1 donor-CU at DU migration. The absence of these information elements in the F1 setup request may indicate that the non-F1 donor CU is also the target F1 donor-CU.

Then, it is proposed that, in the scope of DU migration of a mobile IAB-node, the F1 setup request sent to the target F1 donor-CU may also include the identifier of the non-F1 donor-CU and the XnAP UE ID of the mobile IAB-MT at this CU.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for use in a migration process in which a Distributed Unit, DU, of an Integrated Access Backhaul, IAB, node is migrated from a source F1-terminating IAB donor Central Unit, CU, to another IAB topology a target F1-terminating IAB donor CU, the method at the source F1-terminating IAB donor CU comprising:
sending, to the DU of the IAB node, a message for establishing a F1 connection between the IAB node and the target F1-terminating IAB donor CU in a case where the DU of the IAB node is to be migrated from the source F1-terminating IAB donor CU to the target F1-terminating IAB donor CU.

2. The method of claim 1, further comprising sending, to the IAB node, identification information for identifying the target F1-terminating IAB donor CU.

3. The method of claim 2, wherein the identification information for identifying the target F1-terminating IAB donor CU for the F1 connection includes an address associated with the target F1-terminating IAB donor CU.

4-6. (canceled)

7. The method of claim 1, further comprising receiving, from the IAB node, identification information identifying each of one or more new cells that have been activated at a second logical DU entity of the DU of the IAB node.

8. The method of claim 1, further comprising receiving, from the target F1-terminating IAB donor CU or from the IAB node, mapping information indicating a mapping between identification information of one or more new cells that have been activated at a second logical DU entity of the DU of the IAB node and identification information of one or more active cells controlled by a first logical DU entity of the DU of the IAB node.

9. The method of claim 1, further comprising:
sending, to the target F1-terminating IAB donor CU, a handover request for requesting handover, from the source F1-terminating IAB donor CU to the target F1-terminating IAB donor CU, of one or more User Equipment, UE, served by the IAB node and for identifying one or more candidate target cells for each UE.

10. The method of claim 9, further comprising:
selecting one or more of the new cells as one or more candidate target cells for each UE of one or more UE served by the IAB node based on the mapping information, sending, to the target F1-terminating IAB donor CU, a handover request for requesting handover, from the source F1-terminating IAB donor CU to the target F1-terminating IAB donor CU, of the one or more User Equipment, UE, served by the IAB node,
wherein the handover request includes information identifying the selected one or more candidate target cells.

11. The method of claim 9, further comprising:
in response to receiving a handover acknowledgement from the target F1-terminating IAB donor CU indicating handover of the one or more UE has been accepted and identifying a target cell for each UE, sending to the IAB node, configuration information for configuring each of the one or more UE for the respective target cell.

12. The method of claim 9, further comprising:
after handover of the one or more UE to the target F1-terminating IAB donor CU is completed, sending, to the IAB node, a request for deactivating a first logical DU entity of the DU of the IAB node having a F1 connection with the source F1-terminating IAB donor CU.

13. The method of claim 9, further comprising:
after handover of the one or more UE to the target F1-terminating IAB donor CU is completed and when a Mobile Termination, MT, of the IAB node has been migrated to a non-F1 donor CU, sending, to the non-F1 donor-CU, a traffic migration request for requesting traffic release for the traffic associated with the IAB node and that was routed via one or more paths in an IAB topology managed by the non-F1 donor CU.

14. The method of claim 1, wherein determining the DU of the IAB node is to be migrated comprises determining the DU of the IAB node is to be migrated in response to determining a migration of a MT of the IAB node toward a new parent IAB node has been completed.

15. A method for use in a migration process in which a Distributed Unit, DU, of an Integrated Access Backhaul, IAB, node is migrated from a source F1-terminating IAB donor Central Unit, CU, to a target F1-terminating IAB donor CU, the method at the IAB node comprising:
receiving, at the DU of the IAB node from the source F1-terminating IAB donor CU, a message for establishing a F1 connection between a target F1-terminating IAB donor CU and the IAB node;
sending, to the target F1-terminating IAB donor CU, a F1 setup request for requesting set up of the F1 connection.

16. The method of claim 15, further comprising:
identifying the target F1-terminating IAB donor CU after receiving the message for establishing a F1 connection,
wherein sending comprises sending the F1 setup request to the identified target F1-terminating IAB donor CU.

17. The method of claim 16, further comprising:
receiving, from the source F1-terminating IAB donor CU, identification information for identifying the target F1-terminating IAB donor CU for the F1 connection.

18. The method of claim 16, further comprising:
receiving, from the source F1-terminating IAB donor CU, identification information for identifying the target F1-terminating IAB donor CU for the F1 connection,
wherein identifying the target F1-terminating IAB donor CU comprises identifying the target F1-terminating IAB donor CU from the received identification information.

19. The method of claim 16, wherein identifying comprises:
after determining that identification information for identifying the target F1-terminating IAB donor CU for the F1 connection has been received from the source F1-terminating IAB donor CU, identifying the target F1-terminating IAB donor CU from the received identification information.

20. (canceled)

21. The method of claim 17, further comprising:
after receiving the message for establishing a F1 connection, determining whether identification information for identifying the target F1-terminating IAB donor CU for the F1 connection has been received from the source F1-terminating IAB donor CU;
wherein after determining that identification information for identifying the target F1-terminating IAB donor CU for the F1 connection has been received, sending comprises sending, to the target F1-terminating IAB donor CU identified by the received identification information, the F1 setup request.

22. (canceled)

23. The method of claim 17, wherein the identification information for identifying the target F1-terminating IAB donor CU for the F1 connection includes an address associated with the target F1-terminating IAB donor CU.

24. The method of claim 15, wherein the DU of the IAB-node comprises a first logical DU entity having a F1 connection with the source F1-terminating IAB donor CU, the method further comprising receiving from source F1-terminating IAB donor CU, information indicating a number of cells to be activated at a second logical DU entity of the DU of the IAB node.

25-27. (canceled)

28. The method of claim 15, wherein the DU of the IAB-node comprises a first logical DU entity having a F1 connection with the source F1-terminating IAB donor CU, the method further comprising:
after receiving the message for establishing a F1 connection, activating a second logical DU entity, for establishing the F1 connection with the target F1-terminating IAB donor CU,
wherein sending comprises sending, by the second logical DU entity to the target F1-terminating IAB donor CU, the F1 setup request.

29. The method of claim 28, further comprising:
after sending the F1 setup request, receiving, from the target F1-terminating IAB donor CU, a response, the response including a request for one or more cells to be activated for the second logical DU entity;
activating the one or more cells based on the received response.

30. The method of claim 29, wherein the response includes identification information identifying each of the one or more cells to be activated.

31. The method of claim 29, further comprising sending, to the source F1-terminating IAB donor CU, identification information identifying each of one or more new cells that have been activated at the second logical DU entity.

32. The method of claim 29, further comprising sending, to the source F1-terminating IAB donor CU, mapping information indicating a mapping between identification information of one or more new cells that have been activated at the second logical DU entity and identification information of one or more active cells controlled by a first logical DU entity of the DU of the IAB node.

33. The method of claim 15, wherein the DU of the IAB-node comprises a first logical DU entity having a F1 connection with the source F1-terminating IAB donor CU, the method further comprising:
receiving, from the source F1-terminating IAB donor CU, a request for deactivating the first logical DU entity of the DU of the IAB node having a F1 connection with the source F1-terminating IAB donor CU.

34. The method of claim 33, further comprising:
after receiving the request for deactivating the first logical DU entity, deactivating the first logical DU entity.

35. The method of claim 15, wherein sending the F1 setup request comprises sending a F1 setup request message for requesting set up of the F1 connection, wherein the F1 setup request message includes identification information for identifying the source F1-terminating IAB donor CU or identification information for identifying a non-F1 donor CU when a Mobile Termination, MT, of the IAB node has been migrated to a non-F1 donor CU.

36-37. (canceled)

38. The method of claim 15, wherein sending the F1 setup request comprises sending a F1 setup request message for requesting set up of the F1 connection, wherein the F1 setup request message includes information indicating the request for establishing a F1 connection is related to a migration of the DU of the IAB node.

39-50. (canceled)

51. The method of claim 1, wherein the IAB node is a mobile IAB node.

52. An apparatus for an Integrated Access and Backhaul, IAB, node for an IAB communication system, the apparatus comprising:
at least one processor that executes instructions, the instructions, when executed, causing the apparatus to perform operations comprising:
receiving, at a DU of the IAB node from a source F1-terminating IAB donor Central Unit, CU, a message for establishing a F1 connection between a target F1-terminating IAB donor CU and the IAB node in a case where the DU of the IAB node is to be migrated from the source F1-terminating IAB donor CU to the target F1-terminating IAB donor CU;
sending, to the target F1-terminating IAB donor CU, a F1 setup request for requesting set up of the F1 connection.

53. An apparatus for an Integrated Access and Backhaul, IAB, donor Central Unit, CU, for an IAB communication system, the apparatus comprising:
at least one processor that executes instructions, the instructions, when executed, causing the apparatus to perform operations comprising:
sending, to a Distributed Unit, DU, of an Integrated Access Backhaul, IAB, node in a case where the IAB donor CU is operating as a source F1-terminating IAB donor CU, a message for establishing a F1 connection between the IAB node and a target F1-terminating IAB donor CU in a case where the DU of the IAB node is to be migrated from the source F1-terminating IAB donor CU to the target F1-terminating IAB donor CU.

54. (canceled)

55. A non-transitory computer-readable storage medium carrying a computer program comprising program instructions which, when the computer program is executed by one or more processing units of an Integrated Access and Backhaul, IAB, node, cause the IAB node to:
receive, at a DU of the IAB node from a source F1-terminating IAB donor Central Unit, CU, a message for establishing a F1 connection between a target F1-terminating IAB donor CU and the IAB node in a case where the DU of the IAB node is to be migrated from the source F1-terminating IAB donor CU to the target F1-terminating IAB donor CU;
send, to the target F1-terminating IAB donor CU, a F1 setup request for requesting set up of the F1 connection.

56. The method of claim 1, wherein sending comprises sending, to a first logical DU entity of the IAB node, the message, wherein the first logical DU entity has a F1 connection with the source F1-terminating IAB donor CU.

57. The method of claim 15, wherein the IAB node is a mobile IAB node.

58. The method of claim 15, wherein the DU of the IAB-node comprises a first logical DU entity having a F1 connection with the source F1-terminating IAB donor CU and a second logical DU entity, wherein receiving comprises receiving, at the first logical DU entity of the IAB node, the message for establishing a F1 connection, wherein sending comprises sending, by the second logical DU entity to the target F1-terminating IAB donor CU, the F1 setup request.

59. The apparatus of claim 52, wherein the one or more processing units are further configured to:
identify the target F1-terminating IAB donor CU after receiving the message for establishing a F1 connection,
wherein sending comprises sending the F1 setup request to the identified target F1-terminating IAB donor CU.

60. The apparatus of claim 52, wherein the one or more processing units are further configured to receive, from the source F1-terminating IAB donor CU, identification information for identifying the target F1-terminating IAB donor CU for the F1 connection,
wherein the one or more processing units are configured to identify the target F1-terminating IAB donor CU from the received identification information.

61. The apparatus of claim 59, wherein the one or more processing units are configured to identify the target F1-terminating IAB donor CU by:
after determining that identification information for identifying the target F1-terminating IAB donor CU for the F1 connection has been received from the source F1-terminating IAB donor CU, identifying the target F1-terminating IAB donor CU from the received identification information.

62. The apparatus of claim 60, wherein the one or more processing units are further configured to:
after receiving the message for establishing a F1 connection, determine whether identification information for identifying the target F1-terminating IAB donor CU for the F1 connection has been received from the source F1-terminating IAB donor CU;
wherein after determining that identification information for identifying the target F1-terminating IAB donor CU for the F1 connection has been received, the one or more processing units are configured to send, to the target F1-terminating IAB donor CU identified by the received identification information, the F1 setup request.

63. The apparatus of claim 52, wherein the DU of the IAB-node comprises a first logical DU entity having a F1 connection with the source F1-terminating IAB donor CU, and wherein the one or more processing units are further configured to:
after receiving the message for establishing a F1 connection, activate a second logical DU entity, for establishing the F1 connection with the target F1-terminating IAB donor CU,
wherein the one or more processing units are configured to send, by the second logical DU entity to the target F1-terminating IAB donor CU, the F1 setup request.

64. The apparatus of claim 52, wherein the one or more processing units are further configured to:
after sending the F1 setup request, receive, from the target F1-terminating IAB donor CU, a response, the response including a request for one or more cells to be activated for the second logical DU entity;
activate the one or more cells based on the received response.

65. The apparatus of claim 64, wherein the response includes identification information identifying each of the one or more cells to be activated.

66. The apparatus of claim 64, wherein the one or more processing units are further configured to send, to the source F1-terminating IAB donor CU, identification information identifying each of one or more new cells that have been activated at the second logical DU entity.

67. The apparatus of claim 64, wherein the one or more processing units are further configured to send, to the source F1-terminating IAB donor CU, mapping information indicating a mapping between identification information of one or more new cells that have been activated at the second logical DU entity and identification information of one or more active cells controlled by a first logical DU entity of the DU of the IAB node.

68. The apparatus of claim 52, wherein the DU of the IAB-node comprises a first logical DU entity having a F1 connection with the source F1-terminating IAB donor CU, wherein the one or more processing units are further configured to:
receive, from the source F1-terminating IAB donor CU, a request for deactivating the first logical DU entity of the DU of the IAB node having a F1 connection with the source F1-terminating IAB donor CU.

69. The apparatus of claim 68, the one or more processing units are further configured to:
after receiving the request for deactivating the first logical DU entity, deactivate the first logical DU entity.

70. The apparatus of claim 52, wherein the one or more processing units are configured to send a F1 setup request message for requesting set up of the F1 connection, wherein the F1 setup request message includes identification information for identifying the source F1-terminating IAB donor CU or identification information for identifying a non-F1 donor CU when a Mobile Termination, MT, of the IAB node has been migrated to a non-F1 donor CU.

71. The apparatus of claim 52, wherein the one or more processing units are configured to send a F1 setup request message for requesting set up of the F1 connection, wherein the F1 setup request message includes information indicating the request for establishing a F1 connection is related to a migration of the DU of the IAB node.

72. The apparatus of claim 53, wherein the one or more processing units are configured to send, to a first logical DU entity of the IAB node, the message, wherein the first logical DU entity has a F1 connection with the source F1-terminating IAB donor CU.

73. The apparatus of claim 53, wherein the one or more processing units are further configured to send, to the IAB node, identification information for identifying the target F1-terminating IAB donor CU.

74. The apparatus of claim 53, wherein the one or more processing units are further configured to receive, from the IAB node, identification information identifying each of one or more new cells that have been activated at a second logical DU entity of the DU of the IAB node.

75. The apparatus of claim 53, wherein the one or more processing units are further configured to receive, from the target F1-terminating IAB donor CU or from the IAB node, mapping information indicating a mapping between identification information of one or more new cells that have been activated at a second logical DU entity of the DU of the IAB node and identification information of one or more active cells controlled by a first logical DU entity of the DU of the IAB node.

76. The apparatus of claim 53, wherein the one or more processing units are further configured to:
send, to the target F1-terminating IAB donor CU, a handover request for requesting handover, from the source F1-terminating IAB donor CU to the target I F1-terminating AB donor CU, of one or more User Equipment, UE, served by the IAB node and for identifying one or more candidate target cells for each UE.

77. The apparatus of claim 76, wherein the one or more processing units are further configured to:
after handover of the one or more UE to the target F1-terminating IAB donor CU is completed, send, to the IAB node, a request for deactivating a first logical DU entity of the DU of the IAB node having a F1 connection with the source F1-terminating IAB donor CU.

78. The apparatus of claim 76, wherein the one or more processing units are further configured to:
after handover of the one or more UE to the target F1-terminating IAB donor CU is completed and when a Mobile Termination, MT, of the IAB node has been migrated to a non-F1 donor CU, send, to the non-F1 donor-CU, a traffic migration request for requesting traffic release for the traffic associated with the IAB node and that was routed via one or more paths in an IAB topology managed by the non-F1 donor CU.
